(19) United States
(12) Patent Application Publication
(10) Pub. No.: US 2026/0275147 A1
(43) Pub. Date: Sep. 17, 2026

(54) COATING COMPOSITION AND PAINT-PROTECTIVE COATING MATERIAL

(71) Applicant: NITTO DENKO CORPORATION, Ibaraki-shi, Osaka (JP)

(72) Inventors: Takeshi IGARASHI, Ibaraki-shi, Osaka (JP); Koki HASHIMOTO, baraki-shi, Osaka (JP); Keita MIKI, Ibaraki-shi, Osaka (JP)

(73) Assignee: NITTO DENKO CORPORATION, Ibaraki-shi, Osaka (JP)

(21) Appl. No.: 19/470,126

(22) PCT Filed: Mar. 27, 2024
(86) PCT No.: PCT/JP2024/012146

§ 371 Date: Sep. 29, 2025

(30) Foreign Application Priority Data
Apr. 5, 2023 (JP) 2023-061575

(51) Int. Cl. C09D 129/04; C09D 5/02; C09D 7/63

(52) U.S. Cl. CPC C09D 129/04; C09D 5/022; C09D 7/63

(57) ABSTRACT

Provided is a coating composition that is less susceptible to running and is capable of forming a high-quality paint-protective coating material. The coating composition provided comprises a polymer (A) as a base polymer. The polymer (A) is a polymer of a monomer material comprising an acrylic monomer, and has the form of an aqueous emulsion in which the polymer (A) is dispersed in an aqueous solvent. The coating composition further comprises a polyvinyl alcohol polymer (B) having a saponification degree of 80 mol % or higher and a polymerization degree of 1200 or lower. The amount of the polyvinyl alcohol polymer (B) is 0.3 part by weight or greater and 5.0 parts by weight or less per 100 parts by weight of the polymer (A). The coating composition has a viscosity of 25 Pa·s or higher, determined at 30° C. and 2 rpm using a BH viscometer.

### TECHNICAL FIELD

The present invention relates to a paint-protective coating material and a coating composition for forming a paint-protective coating material.

The present application claims priority to Japanese Patent Application No. 2023-061575 filed on Apr. 5, 2023; the entire contents thereof are incorporated herein by reference.

### BACKGROUND ART

For purposes such as prevention of surface damage in transporting, storing, aging and constructing articles having paint layers (or painted articles, e.g., painted automobiles and their components, or metal plates such as painted steel plates and molded articles therefrom), techniques are known such as adhering protective sheets to the paint layers for protection. A paint-protective sheet used for such purposes is generally constructed as an adhesively single-faced substrate-supported pressure-sensitive adhesive (PSA) sheet having a PSA layer on one face of a substrate sheet (support substrate) so that it can provide protection when adhered via the PSA to an adherend (an object to be protected). After the protective role is completed, the paint-protective sheet is removed (peeled away) from the adherend. Technical literatures related to paint-protective sheets include Patent Document 1.

### CITATION LIST

### Patent Literature

[Patent Document 1] Japanese Patent Application Publication No. 2011-111552
[Patent Document 2] Japanese Patent Application Publication No. 2004-224874

### SUMMARY OF INVENTION

### Technical Problem

When protecting non-flat objects (especially objects having complex three-dimensional shapes such as automobile body shells), it is difficult to increase efficiency in suitable application of paint-protective sheets to the objects. In case of improper application of a paint-protective sheet to an object to be protected, for instance, when the applied paint-protective sheet has wrinkles, the wind may blow into the wrinkles while the post-application object is being stored or transported, thereby peeling off the paint-protective sheet and compromising the intended protection purpose.

On the other hand, it has been suggested to form a protective coat by directly applying a liquid protective coating composition onto the paint layer of an object to be protected and drying the liquid composition on the paint layer. Literatures related to this type of art include Patent Document 2. Patent Document 2 suggests a paint for a pressure roller painting in which the paint is pumped into the inside of the paint roller for application. However, in pressure roller painting, it is generally difficult to control the amount of paint applied (and thus the thickness of the protective film formed after drying), making it difficult to efficiently form a high-quality protective film. In addition, paints designed to suit for pressure roller painting tend to run when applied to non-horizontal surfaces (especially vertical surfaces). This tendency becomes more pronounced when a large amount is applied.

In view of these circumstances, an objective of this invention is to provide a coating composition for forming a paint-protective coating material, which is less susceptible to running and is capable of efficiently forming a high-quality paint-protective coating material. Another related objective is to provide a paint-protective coating material obtained from such a coating composition.

### Solution to Problem

This description provides a coating composition for forming a paint-protective coating material. The coating composition comprises a polymer (A) as a base polymer. The polymer (A) is a polymer of monomers (a monomer material) comprising an acrylic monomer. The coating composition is in the form of an aqueous emulsion in which the polymer (A) is dispersed in an aqueous solvent. The coating composition further comprises a polyvinyl alcohol polymer (B). The polyvinyl alcohol polymer (B) has a saponification degree of 80% by mole (mol %) or higher. The polyvinyl alcohol polymer (B) has a polymerization degree of 1200 or lower. The polyvinyl alcohol polymer (B) content is 0.3 part by weight or greater and 5.0 parts by weight or less per 100 parts by weight of the polymer (A). The coating composition has a viscosity of 25 Pa·s or higher, determined at 30° C. and 2 rpm using a BH viscometer. With the coating composition that includes a suitable amount of the polyvinyl alcohol polymer (B) relative to the polymer (A) and has a BH viscosity of 25 Pa·s or higher, it is possible to efficiently form a high-quality protective film less susceptible to running of the composition. The viscosity measured with a BH viscometer may be abbreviated as “BH viscosity” below.

In some embodiments of the art disclosed herein (encompassing the coating composition, the method for producing the coating composition, the paint protection method, the paint-protective coating material, etc.; the same applies, hereinafter), the coating composition further comprises a thickener. The use of thickener can preferably bring about a coating composition that satisfies the BH viscosity.

In the coating composition according to some preferable embodiments, the monomers forming the polymer (A) includes a carboxy group-containing monomer. In other words, the polymer (A) is preferably a polymer of the monomer material comprising a carboxy group-containing monomer. The art disclosed herein can be preferably implemented in an embodiment that comprises the polymer (A) formed from the monomer material having such a composition.

In the coating composition according to some preferable embodiments, the polymer (A) is formed from the monomers (monomer material) that include a nitrogen-atom-containing monomer (or “N-containing monomer” hereinafter). In other words, the polymer (A) is preferably a polymer of the monomer material comprising a N-containing monomer. The art disclosed herein can be preferably implemented in an embodiment comprising the polymer (A) formed from the monomer material having such a composition. The monomer material can also be a composition that includes a carboxy group-containing monomer and a N-containing monomer.

This description also provides a method for producing the coating composition disclosed herein. The production method includes preparing a polymer emulsion that comprises an aqueous solvent, the polymer (A) and the polyvinyl alcohol polymer (B) contained in an amount of 0.3 part or more and 5.0 parts or less by weight per 100 parts by weight of the polymer (A), and that has a viscosity of 1.0 Pa·s or higher and 4.5 Pa·s or lower at 47 wt % NV (% by weight of the non-volatile content) determined at 30° C. and 2 rpm with a BH viscometer; and adjusting the polymer emulsion viscosity to a BH viscosity of 25 Pa·s or higher at 30° C. and 2 rpm. The coating composition disclosed herein can be preferably produced by such a production method. The “viscosity at 47 wt % NV” refers to the viscosity of a polymer emulsion as is when the solid content (NV) of the polymer emulsion is within the range of 47 wt %±1 wt %. For a polymer emulsion whose NV is outside this range, it refers to the viscosity after the NV is adjusted to within the range of 47 wt %±1 wt %.

This description provides a paint-protective coating material (or abbreviated as “coating material” hereinafter) formed from the coating composition disclosed herein. The coating material can be formed by applying the coating composition onto, for instance, a paint layer to be protected, and allowing it to dry. The coating material can be a dry film of the coating composition disclosed herein. This description provides a paint protection method comprising preparing the coating composition disclosed herein; applying the coating composition to a paint layer of an object to be protected having the paint layer, and drying the coating composition to form a paint-protective coating material that temporarily protects the paint layer. The coating composition is less susceptible to running and sagging and can efficiently form a high-quality coating material on the paint layer of the object to be protected. According to the paint protection method using such a composition, the paint layer can be suitably protected with the coating material. The coating composition can be preferably applied using a slot die.

The scope of invention for which patent protection is being sought by this application includes suitable combinations of the respective elements described in this description.

### BRIEF DESCRIPTION OF DRAWINGS

FIG. 1 shows a cross-sectional diagram schematically illustrating an example of the object protected with the paint-protective coating material according to this invention.

FIG. 2 shows a block chart illustrating an embodiment of the paint protection method according to this invention.

### DESCRIPTION OF EMBODIMENTS

Preferable embodiments of the present invention are described below. Matters necessary to practice this invention other than those specifically referred to in this description can be understood by a person skilled in the art based on the disclosure about implementing the invention in this Description and common technical knowledge at the time the application was filed. The present invention can be practiced based on the contents disclosed in this description and common technical knowledge in the subject field.

In the following drawings, components or units having the same functions may be described with the same symbols allocated and the redundant description may be omitted or simplified. The embodiments illustrated in the drawings are schematic in order to clearly describe the present invention and the drawings do not accurately represent the size or scale of products actually provided.

As used herein, the term “acrylic monomer” comprehensively refers to a monomer having at least one (meth)acryloyl group per molecule (or a “(meth)acryloyl group-containing monomer” hereinafter) and (meth)acrylonitrile. As used herein, the term “(meth)acryloyl” comprehensively refers to acryloyl and methacryloyl. Similarly, the terms “(meth)acrylate,” “(meth)acryl” and “(meth)acrylonitrile” comprehensively refer to acrylate and methacrylate, acryloyl and methacryloyl, and acrylonitrile and methacrylonitrile, respectively.

As used herein, the term “polyvinyl alcohol polymer” (or referred to as PVA hereinafter) refers to a polymer that includes a vinyl alcohol unit (—CH₂CH(OH)) as a repeating unit and comprehensively refers to unmodified PVA and modified PVA. Unmodified PVA refers to PVA whose repeating units are basically vinyl alcohol units (—CH₂CH(OH)—) and vinyl ester units (—CH₂CH(OC(═O)R^{A})—, where R^{A} is an alkyl group, e.g., an alkyl group having 1 to 10 carbon atoms, preferably an alkyl group having 1 to 6 carbon atoms, and typically a methyl group). Examples of modified PVA include PVA having a repeating unit (e.g., a repeating unit having an anionic group) other than a vinyl ester unit (typically a vinyl acetate unit) and PVA having a structure whose vinyl alcohol units are at least partially acetalized.

As used herein, the “aqueous solvent” is water or a solvent mixture comprising water as the primary component (a component accounting for more than 50 wt %). The other solvent(s) forming the solvent mixture besides water can be one, two or more species selected from various water-miscible organic solvents (lower alcohols, etc.). In the aqueous solvent in this description, the water content is typically 90 wt % or higher, or preferably 95 wt % to 100 wt %.

### <Polymer (A)>

The coating composition provided by this description includes a polymer (A) as base polymer. Here, the term “base polymer” refers to a component accounting for more than 50% by weight (wt %) (typically 70 wt % or more, e.g., 90 wt % or more, possibly 95 wt % or more, or even 100 wt %) of the polymer in the coating composition. The base polymer in the paint-protective coating material disclosed herein also means the same. The polymer (A) is a polymer of monomers comprising an acrylic monomer. Thus, the polymer (A) includes a monomeric unit derived from the acrylic monomer.

The polymer (A) may have a calculated Tg (glass transition temperature calculated based on the composition of the monomers forming the polymer (A)) of, for instance, −50° C. or higher and 10° C. or lower. In some embodiments, the calculated Tg of polymer (A) is preferably 0° C. or lower. Having a calculated polymer (A) Tg of 0° C. or lower is advantageous in view of non-marking properties (i.e., protective coat's non-traceability on paint layers after its removal) of the polymer-(A)-containing coating material and is also preferable in view of helping to obtain a coating material having a suitably large elongation at break which is described later. In view of helping to obtain superior non-marking properties, in some embodiments, the calculated polymer (A) Tg can be, for instance, −5° C. or lower, −9° C. or lower (e.g., −10° C. or lower), or −15° C. or lower. It is also advantageous that the polymer (A) has a low calculated Tg in view of improving the removal workability (e.g., reduction of failed removal due to chipping and tearing of the coating material) when removing the coating material from paint layers in a low-temperature environment such as outdoors in winter and also in view of reducing cracking in the coating material caused by a difference in linear expansion coefficient compared to the protected object, etc. On the other hand, in view of the removability and removal workability in a high temperature range, the calculated polymer (A) Tg is suitably −40° C. or higher, advantageously −35° C. or higher, preferably −30° C. or higher, possibly −25° C. or higher, or even −20° C. or higher. The art disclosed herein can be preferably implemented in an embodiment using a polymer (A) that has a calculated Tg of, for instance, −25° C. or higher and −10° C. or lower.

As used herein, the acrylic polymer's calculated Tg refers to the Tg value determined by the Fox equation based on the composition of the monomers used in synthesizing the polymer. As shown below, the Fox equation is a relational expression between the Tg of a copolymer and glass transition temperatures Tgi of homopolymers of the respective monomers constituting the copolymer.

$$1 / Tg = \sum ( Wi / Tgi )$$

In the Fox equation, Tg represents the glass transition temperature (unit: K) of the copolymer, Wi the weight fraction (copolymerization ratio by weight) of a monomer i in the copolymer, and Tgi the glass transition temperature (unit: K) of homopolymer of the monomer i.

As the glass transition temperatures of homopolymers used for determining the calculated Tg value, values found in publicly known documents are used. For example, with respect to the monomers listed below, as the glass transition temperatures of homopolymers of the monomers, the following values are used:
n-butyl acrylate −55° C.
acrylonitrile 97° C.
vinyl acetate 32° C.
methyl methacrylate 105° C.
acrylic acid 106° C.

With respect to the glass transition temperatures of homopolymers of monomers other than those listed above, values given in “Polymer Handbook” (3rd edition, John Wiley & Sons, Inc., Year 1989) are used. When no homopolymer Tg values are given in known documents, values obtained by the method described below. In particular, to a reaction vessel equipped with a thermometer, a stirrer, a nitrogen inlet and a condenser, are added 100 parts by weight of monomer, 0.2 part by weight of azobisisobutyronitrile, and 200 parts by weight of ethyl acetate as a polymerization solvent, and the mixture is stirred for one hour under a nitrogen gas flow. After oxygen is removed in this way from the polymerization system, the mixture is heated to 63° C. and the reaction is carried out for 10 hours. Then, it is cooled to room temperature, and a homopolymer solution having 33% by mass solids content is obtained. Then, this homopolymer solution is applied onto a release liner by flow coating and allowed to dry to prepare a test sample (a sheet of homopolymer) of about 2 mm thickness. This test sample is cut out into a disc of 7.9 mm diameter and is placed between parallel plates; and while applying a shear strain at a frequency of 1 Hz using a rheometer (model name ARES available from TA Instruments, Japan), the viscoelasticity is measured in the shear mode over a temperature range of −70° C. to 150° C. at a heating rate of 5° C./min; and the peak temperature of the tan δ curve is taken as the Tg of the homopolymer.

In some embodiments, the polymer (A) has an SP value of suitably higher than 9.5 (unit: (cal/cm³)^{1/2}; the same applies hereinafter), or preferably 10.0 or higher. The polymer (A)'s such an SP value can be far from (typically far above) the SP value of the paint layer to be protected. For instance, the paint layer can be a urethane-based paint layer formed upon reaction between a polyol (e.g., acrylic polyol) and a polyisocyanate, a paint layer formed from an acid-epoxy crosslinked acrylic paint, or the like. With the polymer (A)'s SP value being far from the paint layer's SP value, the coating material comprising the polymer (A) tends to be less interactive with the paint layer. This serves as advantages such as reduction of failed removal caused by too high a coating material peel strength on the paint layer, reduction of removal workload, reduction of paint layer deformation (making) due to mass transfer between the paint layer and the coating material. In some embodiments, the polymer (A)'s SP value can be above 10.0, 10.5 or higher, 10.8 or higher, 11.2 or higher, or even 11.5 or higher. The maximum SP value of the polymer (A) is not particularly limited. In view of facilitating formation of a coating material with well-balanced properties, in some embodiments, the polymer (A)'s SP value is generally suitably 14.0 or lower, possibly 13.5 or lower, 13.0 or lower, below 12.5, 12.0 or lower, below 12.0, or even 11.5 or lower.

As used herein, the SP value refers to the solubility parameter value determined from the basic structure of the compound by the method proposed by Fedors. The polymer (A)'s SP value can be adjusted by selecting the composition of the monomers forming the polymer (A), in particular, by selecting the monomer species and their quantitative ratio in the monomer material.

In some embodiments, the SP value of the polymer (A) is suitably higher by 0.2 or more than the SP value of the paint layer to be protected, preferably higher by 0.5 or more, more preferably higher by 0.7 or more, or yet more preferably higher by 1.0 or more. With a combination of the polymer (A) and the paint layer subject to protection with such a difference in SP value, good removability and good non-marking properties are likely to be favorably obtained with the coating material comprising the polymer (A).

The polymer (A) in the art disclosed herein is a polymer of monomers (a monomer material) comprising one, two or more species of acrylic monomers. The acrylic monomer content in the monomers is, for instance, possibly 5% by mole (mol %) or higher, suitably 10 mol % or higher, preferably 15 mol % or higher, also possibly 25 mol % or higher, 35% mol % or higher, 45 mol % or higher, above 50 mol %, or even above 70 mol %. In some embodiments, the acrylic monomer content in the monomers can be 85 mol % or higher, 90 mol % or higher, 95 mol % or higher, or even 100 mol %. In some embodiments, the content of acrylic monomer in the monomers can be 50 mol % or lower, 40 mol % or lower, or even 30 mol % or lower.

In some embodiments, the polymer-(A)-forming monomers comprise at least a (meth)acryloyl group-containing monomer. As the (meth)acryloyl group-containing monomer, solely one species or a combination of two or more species can be used. The (meth)acryloyl group-containing monomer content in the monomers is, for instance, possibly 5 mol % or higher, suitably 10 mol % or higher, preferably 15 mol % or higher, more preferably 20 mol % or higher, also possibly 30 mol % or higher, 40 mol % or higher, 45 mol % or higher, 50 mol % or higher, 55 mol % or higher, or even 60 mol % or higher. The (meth)acryloyl group-containing monomer may account for all (i.e., 100 mol %) of the monomers. In view of helping to combine it with up to the prescribed calculated Tg and facilitating formation of a coating material with well-balanced properties, in some embodiments, the (meth)acryloyl group-containing monomer content in the monomers is preferably 95 mol % or lower, more preferably 90 mol % or lower, possibly 85 mol % or lower, 80 mol % or lower, 75 mol % or lower, or even 70 mol % or lower. The art disclosed herein can also be implemented in an embodiment where the (meth)acryloyl group-containing monomer content in the monomers is 65 mol % or lower, 55 mol % or lower, 45 mol % or lower, or even 35 mol % or lower.

The monomer material forming the polymer (A) preferably comprises at least an alkyl (meth)acrylate as the (meth)acryloyl group-containing monomer. By selecting a species and an amount used, the alkyl (meth)acrylate may help adjust the storage modulus, tensile properties, the SP value described later, etc. For the alkyl (meth)acrylate, solely one species or a combination of two or more species can be used.

As the alkyl (meth)acrylate, for instance, a compound represented by the following formula (1) can be preferably used:

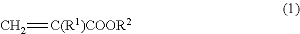

Here, R¹ in the formula (1) is a hydrogen atom or a methyl group. R² in the formula (1) is an acyclic alkyl group having 1 to 20 carbon atoms. Hereinafter, such a range of the number of carbon atoms may be indicated as “C₁₋₂₀.” The acyclic alkyl group can be linear or branched.

Specific examples of the C₁₋₂₀ alkyl (meth)acrylate (alkyl (meth)acrylate wherein R² is a C₁₋₂₀ acyclic alkyl group) are not particularly limited. Examples include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate and eicosyl (meth)acrylate.

Among these, it is preferable to use at least a C₄₋₂₀ alkyl (meth)acrylate (preferably a C₄₋₁₄ alkyl (meth)acrylate). It is more preferable to use a C₄₋₉ alkyl (meth)acrylate as it may contribute to a decrease in the polymer (A)'s calculated Tg. For instance, the monomers preferably include one or both of n-butyl acrylate (BA) and 2-ethylhexyl acrylate (2EHA), and more preferably include at least BA.

Of the polymer-(A)-forming monomers, the C₁₋₂₀ alkyl (meth)acrylate content is, for instance, possibly 5 mol % or higher, suitably 10 mol % or higher, preferably 15 mol % or higher, also possibly 25 mol % or higher, 35 mol % or higher, 45 mol % or higher, 55 mol % or higher, or even 60 mol % or higher. In view of helping to obtain favorable film properties, the C₁₋₂₀ alkyl (meth)acrylate content in the monomers is suitably 95 mol % or lower, preferably 90 mol % or lower, possibly 85 mol % or lower, 80 mol % or lower, 75 mol % or lower, 70 mol % or lower, or even 65 mol % or lower. The art disclosed herein can also be implemented in an embodiment where the C₁₋₂₀ alkyl (meth)acrylate content in the monomers is 60 mol % or lower, 50 mol % or lower, 40 mol % or lower, or 30 mol % or lower.

In an embodiment where the polymer-(A)-forming monomers include a C₄₋₉ alkyl acrylate, the C₄₋₉ alkyl acrylate content in the monomers is, for instance, possibly 5 mol % or higher, or suitably 10 mol % or higher. In view of helping to obtain a lower calculated Tg, it is preferably 15 mol % or higher, 25 mol % or higher, 35 mol % or higher, 40 mol % or higher, or even 45 mol % or higher. On the other hand, in view of helping to obtain a polymer (A) having at least the prescribed SP value, the C₄₋₉ alkyl acrylate content in the monomers is suitably 80 mol % or lower, preferably 70 mol % or lower, possibly 65 mol % or lower, 60 mol % or lower, or even 55 mol % or lower. The art disclosed herein can also be implemented in an embodiment where the C₄₋₉ alkyl acrylate content in the monomers is 50 mol % or lower, 40 mol % or lower, 30 mol % or lower, 25 mol % or lower, or even 20 mol % or lower.

The polymer-(A)-forming monomers may include an alkyl (meth)acrylate and a non-alkyl-(meth)acrylate monomer (a monomer that is not an alkyl (meth)acrylate) together. Examples of the non-alkyl-(meth)acrylate monomer include functional group-containing monomers such as carboxy group-containing monomers, hydroxy (OH) group-containing monomers, cyano group-containing monomers, amide group-containing monomers, amino group-containing monomers, monomers having nitrogen atom-containing rings (N-containing rings), isocyanate group-containing monomers, acid anhydride group-containing monomers, epoxy group-containing monomers, keto group-containing monomers, and alkoxysilyl group-containing monomers. Proper use of functional group-containing monomers can increase the cohesive strength of polymer (A). The functional group-containing monomers may also help adjust the storage modulus, tensile properties, the SP value described later, etc.

Examples of carboxy group-containing monomers include acrylic acid (AA), methacrylic acid (MAA), carboxyethyl (meth)acrylate, carboxypentyl (meth)acrylate, itaconic acid, maleic acid, fumaric acid, crotonic acid and isocrotonic acid. Among them, AA and MAA are preferable.

Examples of hydroxy group-containing monomers include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate and 4-hydroxybutyl (meth)acrylate; and polypropylene glycol mono(meth)acrylate. Particularly preferable hydroxy group-containing monomers include hydroxyalkyl (meth)acrylates having linear alkyl groups with two to four carbon atoms.

Examples of cyano group-containing monomers include acrylonitrile, methacrylonitrile and 2-cyanoethyl (meth)acrylate. Among them, acrylonitrile and methacrylonitrile are preferable. Acrylonitrile is especially preferable.

Examples of amide group-containing monomers include (meth)acrylamide, N,N-dimethyl (meth)acrylamide, N-butyl (meth)acrylamide, N-methylol (meth)acrylamide, N-hydroxyethyl (meth)acrylamide, N-methoxymethyl (meth)acrylamide, N-butoxymethyl (meth)acrylamide, and diacetone (meth)acrylamide.

Examples of amino group-containing monomers include aminoethyl (meth)acrylate, N,N-dimethylaminoethyl (meth)acrylate and t-butylaminoethyl (meth)acrylate.

Examples of monomers having N-containing rings include a monomer having a structure in which a substituent having a polymerizable functional group is bonded to a N-containing ring such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam and N-(meth)acryloyl morpholine. Other examples include maleimide ring-containing monomers such as N-isopropylmaleimide and N-cyclohexylmaleimide.

Examples of isocyanate group-containing monomers include 2-(meth)acryloyloxyethylisocyanate.

Examples of acid anhydride group-containing monomers include maleic acid anhydride and itaconic acid anhydride.

Examples of keto group-containing monomers include diacetone (meth)acrylate, vinyl methyl ketone, vinyl ethyl ketone, allyl acetoacetate and vinyl acetoacetate.

Examples of epoxy group-containing monomers include glycidyl (meth)acrylate, methylglycidyl (meth)acrylate and allyl glycidyl ether.

Examples of alkoxysilyl group-containing monomers include (3-(meth)acryloxypropyl) trimethoxysilane, (3-(meth)acryloxypropyl)triethoxysilane, (3-(meth)acryloxypropyl)methyldimethoxysilane and (3-(meth)acryloxypropyl)methyldiethoxysilane.

For an increase in cohesive strength and like purpose, the polymer-(A)-forming monomers may include other comonomers besides the monomers described above. Examples of the other comonomers include vinyl ester-based monomers such as vinyl acetate (VAc), vinyl propionate and vinyl laurate; aromatic vinyl compounds such as styrene, substituted styrenes (α-methylstyrene, etc.) and vinyltoluene; cycloalkyl (meth)acrylates such as cyclohexyl (meth)acrylate, cyclopentyl (meth)acrylate and isobornyl (meth)acrylate; aromatic ring-containing (meth)acrylates such as aryl (meth)acrylates (e.g., phenyl (meth)acrylate), aryloxyalkyl (meth)acrylate (e.g., phenoxyethyl (meth)acrylate) and arylalkyl (meth)acrylate (e.g., benzyl (meth)acrylate); olefinic monomers such as ethylene, propylene, isoprene, butadiene and isobutylene; chlorine-containing monomers such as vinyl chloride and vinylidene chloride; alkoxy group-containing monomers such as methoxyethyl (meth)acrylate, ethoxyethyl (meth)acrylate, ethyl carbitol (meth)acrylate and ethoxy (diethylene glycol) (meth)acrylate; vinyl ether-based monomers such as methyl vinyl ether and ethyl vinyl ether; and a polyfunctional monomer having two or more (e.g., three or more) polymerizable functional groups (e.g. (meth)acryloyl groups) per molecule, such as 1,6-hexanediol di(meth)acrylate and trimethylolpropane tri(meth)acrylate.

In some embodiments, the polymer-(A)-forming monomers include a N-containing monomer. Examples of the N-containing monomer include monomers corresponding to at least one of the aforementioned cyano group-containing monomer, amide group-containing monomer, amino group-containing monomer, monomer having a N-containing ring, etc. As the N-containing monomer, solely one species or a combination of two or more species can be used. The monomers include a N-containing monomer preferably in combination with an alkyl (meth)acrylate and more preferably with a C₄₋₉ alkyl acrylate. With the N-containing structural moieties, N-containing monomers tend to show relatively high SP values (e.g., higher than those of alkyl (meth)acrylates). By suitably using the N-containing monomer, the resulting polymer (A) is likely to have at least the prescribed SP value. In general, N-containing monomers tend to have high homopolymer Tg values. When a N-containing monomer is used as a monomer forming the polymer (A), the calculated polymer (A) Tg is likely to increase. However, the suitably combined use of the N-containing monomer and C₄₋₉ alkyl acrylate can favorably bring about a polymer (A) that achieves both at least the prescribed SP value and a calculated Tg up to the prescribed value.

In an embodiment where the polymer-(A)-forming monomers include a N-containing monomer, the N-containing monomer content in the monomers can be set to obtain the desirable effect of use. In some embodiments, the N-containing monomer content in the monomers is, for instance, possibly 1 mol % or higher, suitably 5 mol % or higher, preferably 10 mol % or higher, more preferably 15 mol % or higher, possibly 20 mol % or higher, 25 mol % or higher, 30 mol % or higher, or even 35 mol % or higher. On the other hand, in view of readily allowing the polymer (A)'s calculated Tg to be at or below the prescribed value, the N-containing monomer content in the monomers is suitably 70 mol % or lower, preferably 65 mol % or lower, possibly 60 mol % or lower, 55 mol % or lower, 50 mol % or lower, 45 mol % or lower, or even 40 mol % or lower.

In some preferable embodiments, the polymer-(A)-forming monomers include at least acrylonitrile as the N-containing monomer. The inclusion of acrylonitrile in the monomers helps bring about a coating material that combines well-balanced removability and good non-marking properties as well as a coating composition capable of forming the coating material. The content of acrylonitrile in the N-containing monomers included in the monomers can be, for instance, 25 mol % or higher, 50 mol % or higher, 70 mol % or higher, 85 mol % or higher, 95 mol % or higher, or even 100 mol %.

In an embodiment where the polymer-(A)-forming monomers include acrylonitrile, the content of acrylonitrile in the monomers is, for instance, possibly 1 mol % or higher, suitably 5 mol % or higher, preferably 10 mol % or higher, more preferably 15 mol % or higher, also possibly 20 mol % or higher, 25 mol % or higher, 30 mol % or higher, or even 35 mol % or higher. On the other hand, in view of readily keeping the polymer (A)'s calculated Tg at or below a certain value, the content of acrylonitrile in the monomers is suitably 70 mol % or lower, preferably 65 mol % or lower, possibly 60 mol % or lower, 55 mol % or lower, 50 mol % or lower, 45 mol % or lower, or even 40 mol % or lower.

The acid value of polymer (A) is not particularly limited and can be, for instance, 60 mgKOH/g or less. In some embodiments, in view of reducing the peel strength on paint layers, the polymer (A)'s acid value is advantageously 20.0 mgKOH/g or less, preferably 15.0 mgKOH/g or less, more preferably 12.0 mgKOH/g or less, possibly 11.0 mgKOH/g or less, or even 10.0 mgKOH/g or less. The art disclosed herein can also be implemented in an embodiment in which the polymer (A) has an acid value of 8.0 mgKOH/g or less, 6.0 mgKOH/g or less, 3.0 mgKOH/g or less, or 1.0 mgKOH/g or less. The polymer (A)'s acid value can also be at or above 0 mgKOH/g. In some embodiments, in view of increasing the coating material strength (e.g., breaking strength), etc., the polymer (A) may have an acid value of, for instance, 1.0 mgKOH/g or greater, 2.0 mgKOH/g or greater, 4.0 mgKOH/g or greater, or even 7.0 mgKOH/g or greater. It can be advantageous to increase the coating material strength from the standpoint of increasing removal workability (e.g., preventing tearing and chipping during removal).

The acid value of polymer (A) is determined by the potentiometric titration method specified in JIS K0070: 1992. As for the sample for acid value measurement, with respect to the polymer (A) in the coating material, the coating material is placed in chloroform; the resulting mixture is left still for 12 hours and then filtered through a filter; and a substance having a weight average molecular weight of 1×10⁴ or higher (determined by GPC) is used as the sample. For measuring the acid value of the polymer (A) in the coating composition, the coating composition is allowed to dry at 80° C. for 3 minutes to form a film (coating material) of about 100 μm in thickness, the same procedure as the acid value measurement sample for the polymer (A) in the coating material is then carried out, and the resulting substance is used as the sample. The acid value of the polymer (A) in the aqueous polymer (A) emulsion described later is measured, using as the sample, a substance obtained in the same manner as the acid value measurement sample for the polymer (A) in the coating composition. In particular, for instance, diethyl ether and ethanol are mixed at a 4:1 volume ratio. A precisely weighed sample is added to 50 mL of the resulting solvent mixture, and completely dissolved. To this, a phenol phthalein solution is further added as an indicator to prepare a solution for measurement. With respect to the solution for measurement, potentiometric titration is carried out with a 0.1 mol/L potassium hydroxide ethanol solution. The inflection point of the resulting titration curve is used as the end point. The acid value is determined by the equation below. In the undermentioned working examples, the acid values of the polymers (A) were determined by this method.

$$Acid value ( mg KOH \text{/g} ) = ( B \times F \times 5.611 ) / S$$

B: added volume (mL) of 0.1 mol/L potassium hydroxide ethanol solution at the end point.
F: 0.1 mol/L potassium hydroxide ethanol solution (1.0)
S: amount (g) of sample collected.

In some embodiments of the art disclosed herein, the polymer-(A)-forming monomers include a monomer (m_{T}) having a homopolymer Tg of 90° C. or higher and a monomer (m_{L}) having a homopolymer Tg of −30° C. or lower. Here, the monomer (m_{T}) may include a N-containing monomer having a homopolymer Tg of 90° C. or higher. One example of the N-containing monomer whose homopolymer Tg is 90° C. or higher is acrylonitrile (homopolymer Tg: 97° C.). The polymer (A) in such an embodiment can be a polymer of monomers that comprise a monomer (m_{L}) and a monomer (m_{T}) comprising at least a N-containing monomer (e.g., acrylonitrile) and may further comprise other monomers. As for the homopolymer Tg values of the respective monomers, similar to the homopolymer glass transition temperatures used for determining the calculated Tg described above, values given in known documents are used. When no homopolymer Tg values are given in known documents, the inflection point temperature of the loss modulus G″ obtained by the abovementioned measurement method is used.

The monomer (m_{L}) may lower the polymer (A)'s calculated Tg and help enhance the non-marking properties of the coating material comprising the polymer (A). It can be advantageous to lower the polymer (A)'s calculated Tg also in view of enhancing the low-temperature properties (e.g., cracking resistance at low temperatures, breaking/tearing resistance during removal from paint layers at low temperatures, etc.) of the coating material. As the monomer (m_{L}), a species having a homopolymer Tg of −30° C. or lower can be used. It can be selected among, but not limited to, for instance, the aforementioned various monomers. For the monomer (m_{L}), solely one species or a combination of two or more species can be used. Non-limiting specific examples of monomers usable as the monomer (m_{L}) include n-butyl acrylate (BA), 2-ethylhexyl acrylate (2EHA), isooctyl acrylate, isononyl acrylate, isoamyl acrylate, 4-hydroxybutyl acrylate (4HBA), methoxyethyl acrylate, ethyl carbitol acrylate and ethoxy diethyleneglycol acrylate.

The minimum homopolymer Tg of each monomer used as the monomer (m_{L}) is not particularly limited. It can be, for instance, −100° C. or higher, −90° C. or higher, or −80° C. or higher. In some embodiments, as the monomer (m_{L}), a monomer having a homopolymer Tg in the range of −60° C. or higher and −40° C. or lower can be preferably used. Of the monomer (m_{L}), the content of monomer whose homopolymer Tg is in the range of −60° C. or higher and −40° C. or lower can be, for instance, 50 mol % or higher, 75 mol % or higher, 85 mol % or higher, 95 mol % or higher, or even 100 mol %.

The monomer (m_{T}) may help enhance the coating material's cohesive strength and high-temperature properties (e.g., less lowering of storage modulus in a high temperature range, removability at high temperatures, etc.). As the monomer (m_{T}), solely as one species or in a combination of two or more species. The monomer (m_{T}) may include solely one species of N-containing monomer; a combination of two or more species of N-containing monomer; or one, two or more species of N-containing monomer in combination with other monomer(s) (i.e., monomer(s) that are not N-containing monomers, or “N-free monomer(s)” hereinafter) having a homopolymer Tg of 90° C. or higher. As the monomer (m_{T}), it is possible to use acrylonitrile alone, acrylonitrile in combination with a N-free monomer having a homopolymer Tg of 90° C. or higher, or acrylonitrile in combination with a N-free monomer having a homopolymer Tg of 90° C. or higher and a N-containing monomer (other than acrylonitrile). For the N-free monomer having a homopolymer Tg of 90° C. or higher, the corresponding species can be suitably selected among, for instance, the aforementioned various monomers while not limited to these. Among the N-free monomers, solely one species or a combination of two or more species can be used along with a N-containing monomer (e.g., acrylonitrile) having a homopolymer Tg of 90° C. or higher. The maximum homopolymer Tg of each monomer used as the monomer (m_{T}) is not particularly limited. For instance, it can be 250° C. or lower, 200° C. or lower, or even 150° C. or lower.

Non-limiting specific examples of the N-free monomer possibly used as the monomer (m_{T}) include acrylic acid, methacrylic acid, methyl methacrylate, isobornyl acrylate, isobornyl methacrylate, dicyclopentanyl acrylate, dicyclopentanyl methacrylate, adamantyl acrylate and tert-butyl methacrylate. Favorable examples include acrylic acid (AA) and methyl methacrylate (MMA). Non-limiting specific examples of N-containing monomers that can be used as the monomer (m_{T}) include acrylonitrile, methacrylonitrile, acryloylmorpholine and acrylamide. A favorable example is acrylonitrile.

The N-containing monomer content in the monomer (m_{T}) can be 35 mol % or higher. From the standpoint of helping to obtain favorable film properties, it is suitably 50 mol % or higher, or preferably 60 mol % or higher. In some embodiments, the N-containing monomer content in the monomer (m_{T}) can be above 70 mol %, above 80 mol %, above 90 mol %, above 93 mol %, or even 100 mol %. In some embodiments, the N-containing monomer content in the monomer (m_{T}) can be 85 mol % or lower, 75 mol % or lower, 70 mol % or lower, or even 65 mol % or lower.

In some embodiments, the N-containing monomer in the monomer (m_{T}) includes at least acrylonitrile. In such an embodiment, the acrylonitrile content of the N-containing monomer in the monomer (m_{T}) can be, for instance, 25 mol % or higher, 50 mol % or higher, 70 mol % or higher, 85 mol % or higher, 95 mol % or higher, or even 100 mol %.

In an embodiment where the monomer (m_{T}) includes acrylonitrile, the acrylonitrile content of the monomer (m_{T}) can be, for instance, 35 mol % or higher. From the standpoint of helping to obtain favorable film properties, it is suitably 50 mol % or higher, or preferably 60 mol % or higher. In some embodiments, the acrylonitrile content of monomer (m_{T}) can be above 70 mol %, above 80 mol %, above 90 mol %, above 93 mol %, or even 100 mol %. In some embodiments, the acrylonitrile content of monomer (m_{T}) can be 85 mol % or lower, 75 mol % or lower, 70 mol % or lower, or even 65 mol % or lower.

In an embodiment where the polymer-(A)-forming monomers include a monomer (m_{T}) and a monomer (m_{L}), the content of the N-containing monomer having a homopolymer Tg of 90° C. or higher in all the monomers can be, for instance, 20 mol % or higher. From the standpoint of helping to obtain favorable film properties, it is suitably 25 mol % or higher (e.g., 28 mol % or higher), preferably 30 mol % or higher, possibly 35 mol % or higher, or even 40 mol % or higher. The art disclosed herein can be preferably implemented in an embodiment where the N-containing monomer having a homopolymer Tg of 90° C. or higher accounts for more than 50 mol % or more of all the polymer-(A)-forming monomers. From the standpoint of the flexibility of the coating material, the amount of the N-containing monomer having a homopolymer Tg of 90° C. or higher is suitably 60 mol % or lower, or preferably below 60 mol %. In some embodiments, the content of the N-containing monomer having a homopolymer Tg of 90° C. or higher can be 57 mol % or lower, or even 56 mol % or lower. The art disclosed herein can also be implemented in an embodiment where the content of the N-containing monomer having a homopolymer Tg of 90° C. or higher is 53 mol % or lower, 50 mol % or lower, or even 40 mol % or lower.

In an embodiment where the polymer-(A)-forming monomers include a monomer (m_{T}) and a monomer (m_{L}), the acrylonitrile content of all the acrylic polymer-forming monomers can be, for instance, 20 mol % or higher. From the standpoint of helping to obtain favorable film properties, it is suitably 25 mol % or higher (e.g., 28 mol % or higher), preferably 30 mol % or higher, possibly 35 mol % or higher, or even 40 mol % or higher. The art disclosed herein can be preferably implemented in an embodiment where the acrylonitrile content of all the polymer-(A)-forming monomers is above 50 mol %. From the standpoint of the flexibility of the coating material, the acrylonitrile content is suitably 60 mol % or lower, or preferably below 60 mol %. In some embodiments, the acrylonitrile content can be 57 mol % or lower, or even 56 mol % or lower. The art disclosed herein can also be implemented in an embodiment where the acrylonitrile content is 53 mol % or lower, 50 mol % or lower, or even 40 mol % or lower.

In the monomers, the molar ratio (m/m_{L}) between the monomer (m_{T}) and the monomer (m_{L}) is not particularly limited. For instance, it can be about 0.05 to 3.00, or about 0.10 to 2.00. When the ratio m_{T}/m_{L} is, for instance, 0.60 or higher and 1.50 or lower, the resulting coating material is likely to have storage moduli at the respective temperatures in the aforementioned ranges. In some embodiments, the ratio m_{T}/my is preferably below 1.5, more preferably 1.4 or lower, possibly 1.35 or lower, 1.30 or lower, below 1.30 (e.g., 1.29 or lower), 1.28 or lower, or even 1.25 or lower. In some embodiments, the ratio m_{T}/m_{L} is preferably 0.70 or higher, more preferably 0.75 or higher, possibly 0.90 or higher, 1.0 or higher, or even above 1.0. This can bring about a coating material that combines good removability from paint layers and good removal workability at a higher level with good balance. The ratio m_{T}/my can also be 1.1 or higher, 1.15 or higher, 1.20 or higher, 1.22 or higher, or 1.25 or higher.

The polymer-(A)-forming monomers may further include other monomer(s) besides the monomers (m_{T}) and (m_{L}), that is, a monomer (or a monomer (m_{I}) hereinafter) having a homopolymer glass transition temperature of higher than −30° C. and lower than 90° C. As the monomer (m_{I}), a species having a homopolymer glass transition temperature in the range can be selected among for instance, the aforementioned various monomers while it is not limited to these. For the monomer (m_{I}), solely one species or a combination of two or more species can be used. Non-limiting specific examples of monomers usable as the monomer (m_{I}) include ethyl acrylate (EA), ethyl methacrylate, methyl acrylate (MA), n-butyl methacrylate, isobutyl methacrylate, 2-hydroxyethyl acrylate, 2-hydroxyethyl methacrylate, 2-hydroxypropyl acrylate, 2-hydroxypropyl methacrylate, cyclohexyl acrylate, cyclohexyl methacrylate, vinyl acetate and N-vinyl-2-pyrrolidone.

The amount of monomer (m_{I}) can be suitably selected in the range up to the amount (mol %) obtained by subtracting the amounts (mol %) of monomers (m_{T}) and (m_{L}) from the amount of all monomers (100 mol %). In some embodiments, of all the monomers, the amount of monomer (m_{I}) is suitably no more than 80 mol % (e.g., no more than 40 mol %), advantageously no more than 30 mol %, preferably no more than 20 mol %, or more preferably no more than 15 mol %. The art disclosed herein can be preferably practiced in an embodiment where the amount of monomer (m_{T}) used is 0 mol % or greater and below 10 mol % of all monomers, for instance, 0 mol % or greater and below 5 mol %. Here, that the amount of monomer (m_{T}) used is 0 mol % of all monomers means that no monomer (m_{T}) is used at least intentionally.

### <Synthesis of Polymer (A)>

The method for obtaining a polymer (A) from monomers as those described above is not particularly limited. Known polymerization methods can be suitably employed, such as emulsion polymerization, solution polymerization, bulk polymerization, and suspension polymerization. It is also possible to employ photopolymerization involving irradiation of light such as UV (typically carried out in the presence of a photopolymerization initiator) and active energy ray irradiation polymerization such as radiation polymerization involving irradiation of radioactive rays such as B rays and y rays. For facile preparation of the coating composition in the form of an aqueous emulsion with the polymer (A) dispersed in an aqueous solvent, in some preferable embodiments, the polymer (A) is obtained by emulsion polymerization of monomers having an aforementioned composition. As the monomer supply method in emulsion polymerization, a suitable method can be employed among the all-at-once method where all the starting monomer mixture is supplied in one portion, gradual supply method, portion-wise supply method, etc. An emulsion of some or all of the monomers pre-mixed with water and emulsifier can be supplied to the polymerization vessel.

The polymerization temperature can be suitably selected in accordance with the monomer species, the solvent species, and the polymerization initiator species used, etc. The polymerization temperature is suitably about 20° C. or higher, preferably about 40° C. or higher, more preferably about 50° C. or higher; it can also be about 60° C. or higher, about 65° C. or higher, or even about 70° C. or higher. The polymerization temperature is suitably about 170° C. or lower (typically about 140° C. or lower), or preferably about 95° C. or lower (e.g. about 85° C. or lower). In emulsion polymerization, the polymerization temperature is preferably about 95° C. or lower (e.g. about 85° C. or lower). In the polymerization, a known or commonly used thermal polymerization initiator or photopolymerization initiator can be used in accordance with the polymerization method and polymerization conditions. For the polymerization initiator, solely one species or a combination of two or more species can be used.

While no particular limitations are imposed, as the thermal polymerization initiator, it is possible to use, for example, an azo-based initiator, peroxide-based initiator or redox-based initiator by the combination of a peroxide and a reducing agent.

Examples of azo-based initiators include 2,2′-azobisisobutyronitrile, 2,2′-azobis [N-(2-carboxyethyl)-2-methylpropionamidine]hydrate, 2,2′-azobis(2-methylpropionamidine)disulfate salt, 2,2′-azobis(2-methylpropionamidine) dihydrochloride, 2,2′-azobis(2-methylpropionamidine) dihydrochloride, 2,2′-azobis [2-(5-methyl-2-imidazolin-2-yl) propane]dihydrochloride and 2,2′-azobis(N,N′-dimethylene isobutylamidine) dihydrochloride.

Examples of peroxide-based initiators include persulfates such as potassium persulfate and ammonium persulfate; benzoyl peroxide, t-butyl hydroperoxide, di-t-butyl peroxide, dicumyl peroxide, dilauroyl peroxide, di-n-octanoyl peroxide, di(4-methylbenzoyl) peroxide, t-butyl peroxybenzoate, t-butyl peroxyisobutyrate, t-hexyl peroxypivalate, t-butyl peroxypivalate, di(2-ethylhexyl) peroxydicarbonate, di(4-t-butylcyclohexyl) peroxydicarbonate, di-sec-butyl peroxydicarbonate, t-butyl peroxyneodecanoate, 1,1,3,3-tetramethyl butylperoxy-2-ethylhexanoate, 1,1-bis(t-butylperoxy)-3,3,5-trimethylcyclohexane, 1,1-bis(t-butylperoxy)cyclododecane, 1,1-bis(t-hexylperoxy)cyclohexane and hydrogen peroxide.

Examples of redox-based initiators include a combination of a peroxide and ascorbic acid (combination of hydrogen peroxide water and ascorbic acid, etc.), a combination of a peroxide and an iron (II) salt (combination of hydrogen peroxide water and an iron (II) salt, etc.), a combination of a persulfate salt and a metabisulfite (e.g., ammonium persulfate and sodium metabisulfite), and a combination of a persulfate salt and a sulfite salt (e.g., sodium hydrogen sulfite).

The photopolymerization initiator is not particularly limited. It is possible to use, for instance, ketal-based photopolymerization initiators, acetophenone-based photopolymerization initiators, benzoin ether-based photopolymerization initiators, acylphosphine oxide-based photopolymerization initiators, α-ketol photopolymerization initiators, aromatic sulphonyl chloride-based photopolymerization initiators, photoactive oxime-based photopolymerization initiators, benzoin-based photopolymerization initiators, benzylic photopolymerization initiators, benzophenone-based photopolymerization initiators, and thioxanthone-based photopolymerization initiators.

The polymerization initiator can be used in a usual amount in accordance with the polymerization method, embodiment of polymerization, etc., and there are no particular limitations to the amount. For instance, relative to 100 parts by weight of monomers to be polymerized, about 0.001 part to 5 parts by weight (typically about 0.01 part to 2 parts by weight, e.g. about 0.01 part to 1 part by weight) of polymerization initiator can be used.

For the polymerization, as necessary, various heretofore known chain transfer agents (which can be considered also as a molecular weight-adjusting agent or polymerization degree-adjusting agent) can be used. For the chain transfer agent, solely one species or a combination of two or more species can be used. As the chain transfer agent, mercaptans can be used, such as n-dodecyl mercaptan, t-dodecyl mercaptan and thioglycolic acid. Alternatively, a chain transfer agent free of sulfur atoms (a sulfur-free chain transfer agent) can be used as well. Specific examples of the sulfur-free chain transfer agent include anilines such as N,N-dimethylaniline and N,N-diethylaniline; terpenoids such as «-pinene and terpinolene; styrenes such as α-methylstyrene and «-methylstyrene dimer; compounds having benzylidenyl groups such as dibenzylidene acetone, cinnamyl alcohol and cinnamyl aldehyde; hydroquinones such as hydroquinone and naphthohydroquinone; quinones such as benzoquinone and naphthoquinone; olefins such as 2,3-dimethyl-2-butene and 1,5-cyclooctadiene; alcohols such as phenol, benzyl alcohol and allyl alcohol; and benzyl hydrogens such as diphenylbenzene and triphenylbenzene.

When using a chain transfer agent, it can be used in an amount of, for instance, about 0.01 part to 1 part by weight to 100 parts by weight of the monomers. The art disclosed herein can also be preferably implemented in an embodiment that uses no chain transfer agent.

Emulsion polymerization is usually carried out in the presence of an emulsifier. The emulsifier used in the emulsion polymerization is not particularly limited; known anionic emulsifiers, nonionic emulsifiers and the like can be used. These emulsifiers can be used singly as one species or in a combination of two or more species.

Non-limiting examples of anionic emulsifiers include sodium lauryl sulfate, ammonium lauryl sulfate, sodium dodecyl benzene sulfonate, sodium polyoxyethylene lauryl sulfate, sodium polyoxyethylene alkyl ether sulfates, ammonium polyoxyethylene alkyl phenyl ether sulfates, sodium polyoxyethylene alkyl phenyl ether sulfates, and sodium polyoxyethylene alkyl sulfosuccinates. Non-limiting examples of non-ionic emulsifiers include polyoxyethylene alkyl ethers, polyoxyethylene alkyl phenyl ethers, polyoxyethylene aliphatic acid esters, and polyoxyethylene-polyoxypropylene block polymers. Reactive functional group-containing emulsifiers (reactive emulsifiers) can be used as well. Examples of reactive emulsifiers include a radically polymerizable emulsifier having a structure of an aforementioned anionic emulsifier or nonionic emulsifier with a radically polymerizable group such as propenyl group and ally ether group introduced therein.

In the emulsion polymerization, the emulsifier can be used in an amount of, for instance, 0.2 part by weight or greater, 0.5 part by weight or greater, or 1.0 part by weight or greater, or even 1.5 parts by weight or greater, relative to 100 parts by weight of the monomers. In some embodiments, the amount of emulsifier used is usually suitably 10 parts by weight or less to 100 parts by weight of the monomers, preferably 5 parts by weight or less, or possibly even 3 parts by weight or less.

In some preferable embodiments, the emulsion polymerization can be carried out in the presence of a protective colloid. Examples of the protective colloid include polyvinyl alcohol-based polymers (PVA); cellulose derivatives such as hydroxyethyl cellulose, hydroxypropyl cellulose and carboxymethyl cellulose; and natural polysaccharides such as guar gum. For the protective colloid, solely one species or a combination of two or more species can be used.

The amount of protective colloid used per 100 parts by weight of monomers is suitably 0.1 part by weight or greater, advantageously 0.3 part by weight or greater, preferably 0.5 part by weight or greater (e.g., 0.7 part by weight or greater), possibly 1.0 part by weight or greater, 1.5 parts by weight or greater, 2.0 parts by weight or greater, or 2.5 parts by weight or greater. The amount of protective colloid used per 100 parts by weight of monomers can be, for instance, 10 parts by weight or less, 5.0 parts by weight or less, 4.0 parts by weight or less, 3.5 parts by weight or less, 3.0 parts by weight or less, or 2.5 parts by weight or less.

In some preferable embodiments, emulsion polymerization is carried out in the presence of a PVA. Aqueous polymer (A) emulsions obtained by such emulsion polymerization tend to bring about thickening effect upon addition of thickeners. By using an aqueous emulsion of such a polymer (A), it is possible to suitably prepare a coating composition that shows viscosity properties with good non-running properties. It can be advantageous to carry out emulsion polymerization in the presence of a PVA also in view of helping to obtain a coating composition that shows viscosity properties suited for slot-die coating. Preferable PVAs include, but are not limited to, an undermentioned polymer (B). A PVA that does not fall under the polymer (B) (or “non-polymer (B) PVA”) can also be used. A PVA that falls under the polymer (B) (or “polymer (B) PVA”) and a non-polymer (B) PVA can be used in combination as well. In some preferable embodiments, emulsion polymerization to obtain the polymer (A) is carried out in the presence of a PVA and 50 wt % or more (preferably 70 wt % or more, more preferably 90 wt % or more, or possibly 100 wt %) of the PVA corresponds to a polymer (B) PVA. The polymer (B) thus used in emulsion polymerization is preferably one, two or more species selected from the group consisting of unmodified PVAs and anionic PVAs (e.g., carboxylated PVAs).

The protective colloid (e.g., a polymer (B) PVA) can be used in combination with an aforementioned emulsifier, or can be used without using an emulsifier. In some preferable embodiments, an aforementioned emulsifier and a protective colloid are used together. For instance, emulsion polymerization can be carried out in the following embodiment: water and a protective colloid are placed into a polymerization vessel; monomers are partially or entirely pre-mixed and emulsified with water and an emulsifier; and the resulting emulsion is supplied to the polymerization vessel. When using an anionic protective colloid (e.g., anionic PVA) and an emulsifier together, from the standpoint of the polymerization stability and like, as the emulsifier, it is preferable to use one, two or more species selected from the group of anionic emulsifiers and nonionic emulsifiers.

### <Polyvinyl Alcohol Polymer (B)>

The coating composition provided by this description comprises a polyvinyl alcohol polymer (B). As the polyvinyl alcohol polymer (B) (or abbreviated as “polymer (B)” hereinafter) in the art disclosed herein, one, two or more species of PVAs that satisfy the prescribed saponification degree and polymerization degree are used. The use of polymer (B) can improve film-forming properties (e.g., suppression of cracking) and non-running properties when forming a paint-protective coating material from a coating composition in an aqueous emulsion form.

In view of drying properties in forming a paint-protective coating material from a coating composition in an aqueous emulsion form, the PVA used as the polymer (B) has a saponification degree of suitably 80 mol % or higher, more preferably 82 mol % or higher, possibly 84 mol % or higher, 85 mol % or higher, 86 mol % or higher, 87 mol % or higher, 88 mol % or higher, 90 mol % or higher, or 93 mol % or higher. In some embodiments, as the polymer (B), it is possible to use a PVA having a saponification degree of 95 mol % or higher (e.g., 96 mol % or higher, 98 mol % or higher, or 99 mol % or higher), which is also referred to as a fully saponified PVA in general. In some embodiments, in view of the film-forming properties, etc., the saponification degree of the PVA used as the polymer (B) can be, for instance, below 99 mol %, 98 mol % or lower, 97 mol % or lower, 90 mol % or lower (e.g., below 90 mol %), 89 mol % or lower, or 88 mol % or lower. It may also be advantageous to have not to high a saponification degree in view of emulsion stability.

In view of the drying properties, emulsion stability, etc., the PVA used as the polymer (B) has a polymerization degree of suitably 1200 or lower, preferably 1000 or lower, possibly 900 or lower, 800 or lower, 700 or lower, 600 or lower, or 500 or lower. The minimum polymerization degree of the PVA is not particularly limited and can be appropriately selected to suitably obtain the effect of its use. In some embodiments, the polymerization degree of the PVA used as the polymer (B) is suitably 200 or higher, preferably 300 or higher, possibly 400 or higher, or 500 or higher.

The saponification degree and polymerization degree of PVA are measured based on JIS K6726: 1994. If nominal values are provided by the manufacturer or dealer, these values may be used.

The PVA used as the polymer (B) can be modified or unmodified. One, two or more species of modified PVA can be used together with one, two or more species of unmodified PVA. Examples of modified PVA include an anion-modified PVA in which an anionic group (e.g., a carboxy group, sulfonic acid group, phosphate group, etc.) has been introduced; a cation-modified PVA in which a cationic group (e.g., a quaternary ammonium salt, etc.) has been introduced; and a nonion-modified PVA in which an oxyalkylene (e.g., oxyethylene, oxypropylene, etc.) or a polyoxyalkylene structure with repeating oxyalkylene units has been introduced into the side chains. An anion-modified PVA can be obtained, for instance, by saponifying a copolymer of an anionic group-containing monomer and a vinyl ester (e.g., vinyl acetate). Preferable anionic groups in the anion-modified PVA include carboxy and sulfonic acid groups. In some preferable embodiments, one, two or more species selected from the group consisting of unmodified PVAs and anion-modified PVAs (e.g., carboxylated PVA, sulfonic acid-modified PVA, etc.) are used as the polymer (B).

The polymer (B) in the coating composition disclosed herein can be a protective colloid used in synthesizing the polymer (A) by emulsion polymerization. The polymer (B) in the coating composition disclosed herein may be added afterwards to an aqueous polymer (A) emulsion obtained by emulsion polymerization in the absence of the polymer (B), or may be added during or after the preparation of an aqueous emulsion in which the polymer (A) obtained by a non-emulsion polymerization method (e.g., solution polymerization) is dispersed in an aqueous solvent. In some preferable embodiments, at least a portion of the polymer (B) in the coating composition is a protective colloid used in the emulsion polymerization. Of the total amount of polymer (B) in the coating composition, the amount of polymer (B) used as the protective colloid is, for instance, 50 wt % or greater, preferably 70 wt % or greater, more preferably 90 wt % or greater, or possibly 100 wt %.

In the coating composition disclosed herein, in view of helping to suitably obtain the effect of using the polymer (B), the amount of polymer (B) (when using two or more species of PVA as the polymer (B), their combined amount) per 100 parts by weight of polymer (A) is suitably 0.3 part by weight or greater, advantageously 0.5 part by weight or greater (e.g., 0.7 part by weight or greater), preferably 1.0 part by weight or greater, possibly 1.5 parts by weight or greater, 2.0 parts by weight or greater, or 2.5 parts by weight or greater. In view of the drying properties of the coating composition, etc., the polymer (B) content per 100 parts of polymer (A) by weight is suitably 5.0 parts by weight or less, preferably 4.0 parts by weight or less, possibly 3.5 parts by weight or less, 3.0 parts by weight or less, or 2.5 parts by weight or less. The polymer (B) content described above is also applicable to the amount of polymer (B) allowed to be present per 100 parts by weight of monomers when the polymer (A) is obtained by emulsion polymerization in the presence of polymer (B). Having not too large an amount of polymer (B) can also be advantageous in view of polymerization stability when obtaining the polymer (A) by emulsion polymerization in the presence of polymer (B) and the stability of the resulting emulsion, etc.

The coating composition disclosed herein may further include a non-polymer (B) PVA in addition to the polymer (B). In view of helping to suitably obtain the effect of using the polymer (B), of the entire PVA (i.e., the total amount of polymer (B) PVA and non-polymer (B) PVA), the amount of non-polymer (B) PVA is suitably less than 50 wt %, preferably less than 20 wt %, or more preferably less than 10 wt % (e.g., less than 5 wt %). The coating composition can be essentially free of a non-polymer (B) PVA.

### <Other Components>

The coating composition disclosed herein can include other optional components as desired. Examples of such optional components include known additives such as thickener, thixotropic agent, dispersing agent, defoaming agent and inorganic powder. For instance, various additives can be added to an aqueous emulsion (polymerization reaction mixture) of polymer (A) obtained by emulsion polymerization as described above to prepare a coating composition as an aqueous emulsion including the additives. For instance, when an aqueous emulsion of polymer (A) is obtained by emulsion polymerization in the presence of a polymer (B), the aqueous polymer (A) emulsion can be used as the coating composition as is or after pH adjustment (e.g., pH adjusted to about 6 to 8 by addition of ammonia water) and/or concentration adjustment (e.g., NV adjusted to about 40 wt % to 60 wt % by adding water).

### (Thickener)

Thickener may help adjust the viscometric properties of the coating composition. As the thickener, known thickeners can be used such as urethane-based thickeners, cellulose-based thickeners, polyether-based thickeners and acrylic thickeners. For the thickener, solely one species or a combination of two or more species can be used.

Examples of commercial urethane-based thickeners include product names RHEOBYK-H 3300VF, RHEOBYK-T 1010 and RHEOBYK-L 1400 available from BYK; product names ADEKA NOL UH-450VF, ADEKA NOL UH-420, ADEKA NOL UH-462, ADEKA NOL UH-472, ADEKA NOL UH-540, ADEKA NOL UH-756VF and ADEKA NOL UH-814N available from ADEKA Corporation; and SN-THICKENER 612, SN-THICKENER 621N, SN-THICKENER 625N, SN-THICKENER 627N and SN-THICKENER 660T available from San Nopco, Ltd. In some embodiments, as the urethane-based thickener, a urethane associative thickener can be preferably used. Favorable examples of the urethane associative thickener include product names RHEOBYK-H 3300VF, RHEOBYK-T 1010 and RHEOBYK-L 1400 available from BYK; and product names ADEKA NOL UH-450VF and ADEKA NOL UH-420 available from ADEKA.

Examples of cellulose-based thickeners include hydroxyethyl cellulose, carboxymethyl cellulose and methyl cellulose. Examples of commercial products include product name SANHEC L available from Sansho Co., Ltd.

Examples of polyether-based thickeners include polyethylene glycol, polyether dialkyl esters, polyether dialkyl ethers and epoxidized polyether. Examples of commercial products include product name POLYOX WSR N-80 available from Dow Chemical Company.

Examples of acrylic thickeners include acrylate-based polymers such as sodium polyacrylate. Examples of commercial products include PRIMAL ASE-60, PRIMAL TT-615 and PRIMAL RM-5 available from Rohm and Haas Company; and SN-THICKENER 613, SN-THICKENER 618, SN-THICKENER 630, SN-THICKENER 634 and SN-THICKENER 636 available from San Nopco, Ltd.

The amount of thickener used is not particularly limited and can be suitably adjusted to obtain desirable viscometric properties (e.g., BH viscosity measured at 30° C. and 2 rpm). From the standpoint of reducing excessive influence on film properties, in some embodiments, the amount of thickener used to 100 parts by weight of polymer (A) is suitably 15 parts by weight or less, preferably 10 parts by weight or less, more preferably 5.0 parts by weight or less (e.g., 3.0 parts by weight or less), possibly 2.5 parts by weight or less, 2.0 parts by weight or less, or 1.5 parts by weight or less. The minimum amount of thickener used is not particularly limited. For instance, to 100 parts by weight of polymer (A), it can be 0.01 part by weight or greater, 0.05 part by weight or greater, 0.1 part by weight or greater, 0.3 part by weight or greater, or 0.5 part by weight or greater.

### (Inorganic Powder)

Inorganic powder is included in the coating composition to form an inorganic powder-containing coating material. According to such a coating material, with the inorganic powder blocking light such as UV rays, photodegradation can be inhibited in the coating material itself as well as in the paint layer protected with the coating material. As the inorganic powder, oxides such as titanium dioxide, zinc oxide, magnesium oxide, alumina and silica; carbonates such as calcium carbonate; sulfates such as barium sulfate; and the like can be used. Inorganic powder capable of coloring the paint-protective coating material in white is preferable. With the white-colored paint-protective coating material, for instance, the temperature rise in sunlight can be reduced to better inhibit degradation of the coating material and the paint layer.

The amount of inorganic powder used per 100 parts by weight of polymer (A) can be, for instance, 0.5 part by weight or greater. From the standpoint of the light-blocking effect, it is suitably 1 part by weight or greater, preferably 2 parts by weight or greater, more preferably 3 parts by weight or greater, possibly 5 parts by weight or greater, 10 parts by weight or greater, 15 parts by weight or greater, or 20 parts by weight or greater. The amount of inorganic powder used per 100 parts by weight of polymer (A) can be, for instance, 100 parts by weight or less. From the standpoint of the coating material strength and ease of coating, it is suitably 80 parts by weight or less, advantageously 60 parts by weight or less, preferably 50 parts by weight or less, possibly 40 parts by weight or less, or 30 parts by weight or less.

In some preferable embodiments, the inorganic power comprises at least titanium dioxide (TiO₂). Titanium dioxide can also be used in combination with one, two or more species of other inorganic powder (e.g., calcium carbonate). The type of titanium dioxide is not particularly limited. For instance, titanium dioxide in any crystal form such as rutile, anatase and brookite can be used. In particular, rutile titanium dioxide is preferable. Titanium dioxide having coated particle surfaces can be used as well. The coating material of the titanium dioxide particles is not particularly limited. For instance, it can be an inorganic oxide such as silica, alumina and zinc oxide. Favorable examples include highly weather-resistant titanium dioxide (typically rutile titanium dioxide) having particle surfaces coated with Si—Al₂O₃, etc.

The amount of titanium dioxide used to 100 parts by weight of polymer (A) can be, for instance, 0.1 part by weight or greater. From the standpoint of the light-blocking effect, it is suitably 0.5 part by weight or greater, preferably 1 part by weight or greater, more preferably 2 parts by weight or greater, or possibly even 3 parts by weight or greater. The amount of titanium dioxide used to 100 parts by weight of polymer (A) is, for instance, possibly 30 parts by weight or less, suitably 20 parts by weight or less, preferably 15 parts by weight or less, possibly 10 parts by weight or less, or even 8 parts by weight or less.

The mean particle diameter of the inorganic powder is not particularly limited. For instance, from the standpoint of obtaining good light-blocking effect, the inorganic powder has a mean particle diameter of preferably 150 nm or greater, more preferably 180 nm or greater, possibly 220 nm or greater, or even 250 nm or greater. On the other hand, from the standpoint of the dispersity in resins, the mean particle diameter of the inorganic powder is suitably 2000 nm or less, preferably 1500 nm or less, more preferably 1000 nm or less (e.g., 800 nm or less), possibly 500 nm or less, 400 nm or less, or even 350 nm or less. For instance, it is preferable to use titanium dioxide particles having a mean particle diameter of about 250 nm to 350 nm.

### (Thixotropic Agent)

Thixotropic agent may help adjust the viscometric properties of the coating composition. As the thixotropic agent, an inorganic material can be used, for instance, bentonite, modified bentonite, montmorillonite, hectorite, etc. For the thixotropic agent, solely one species or a combination of two or more species can be used.

The amount of thixotropic agent used is not particularly limited and can be suitably adjusted to obtain desirable viscometric properties. From the standpoint of reducing excessive influence on film properties, in some embodiments, the amount of thixotropic agent used to 100 parts by weight of polymer (A) is suitably 10 parts by weight or less, preferably 5.0 parts by weight or less, possibly 3.0 parts by weight or less, 2.5 parts by weight or less, or even 2.0 parts by weight or less. The minimum amount of thixotropic agent used is not particularly limited. For instance, to 100 parts by weight of polymer (A), it can be 0.01 part by weight or greater, 0.05 part by weight or greater, or even 0.1 part by weight or greater.

The thixotropic agent may also serve as a thickener. These thickener and thixotropic agent can be used together, or just one of them can be used. When using a thickener and thixotropic agent together, their combined amount used to 100 parts by weight of polymer (A) can be, for instance, 15 parts by weight or less, 10 parts by weight or less, 5.0 parts by weight or less, 4.0 parts by weight or less, 3.0 parts by weight or less, 2.5 parts by weight or less, 2.0 parts by weight or less, or 1.5 parts by weight or less. The combined amount of thickener and thixotropic agent used per 100 parts by weight of polymer (A) can be, for instance, 0.01 part by weight or greater, 0.05 part by weight or greater, 0.1 part by weight or greater, 0.3 part by weight or greater, or 0.5 part by weight or greater. It can also be 0.7 part by weight or greater, 1.0 part by weight or greater, or 1.5 parts by weight or greater.

### <Properties of Coating Composition>

### (BH Viscosity)

Measured at 30° C. and 2 rpm using a BH viscometer, the coating composition disclosed herein has a viscosity (V_{B2}) of suitably 25 Pa·s or higher, advantageously 30 Pa·s or higher (e.g., 32 Pa·s or higher), preferably 40 Pa·s or higher (e.g., 45 Pa·s or higher), or more preferably 50 Pa·s or higher (e.g., 55 Pa·s or higher). With increasing viscosity determined at such a low shear rate, the non-running properties of the coating composition applied on the object to be protected (e.g., the non-running properties when applied to a vertical surface) tends to improve. On the other hand, from the standpoint of the defoaming properties and leveling properties of the coating composition, the coating composition's viscosity (V_{B2}) is suitably 200 Pa·s or lower, preferably 150 Pa·s or lower, or more preferably 100 Pa·s or lower (e.g., 80 Pa·s or lower).

In the coating composition disclosed herein, the viscosity (V_{B20}) measured at 30° C. and 20 rpm using a BH viscometer is not particularly limited and can be, for instance, about 5 Pa·s to 50 Pa·s. When the viscosity (V_{B20}) is in this range, the resulting coating composition is likely to have a viscosity (V_{B2}) in the aforementioned ranges.

The BH viscosity (viscosity determined with a BH viscometer) of the coating composition is determined with a BH viscometer at 30° C. at 2 and 20 rpm. The rotor used for the measurement is suitably selected according to the viscosity. For instance, when the measuring device has a scale ranging from 0 to 100, a rotor that falls within the range of 10 to 90 on the scale can be selected for the measurement.

### (Rheometer Viscosity)

In some embodiments, determined using a cone plate rheometer, the coating composition has a viscosity (V_{R100}) at a shear rate of 100 sec⁻¹ of preferably 1.0 Pa·s or higher, more preferably 1.3 Pa·s or higher, possibly 1.5 Pa·s or higher, 2.0 Pa·s or higher, or even 2.3 Pa·s or higher. When the viscosity (V_{R100}) determined at such a high shear rate is at least the prescribed values, the slot-die applicability (die-coating properties) can be increased. The maximum viscosity (V_{R100}) is not particularly limited. From the standpoint of the ease of combining with defoaming properties and ease of fluid feeding, it is suitably 15 Pa·s or lower, preferably 10 Pa·s or lower, possibly 8.5 Pa·s or lower, or even 6.0 Pa·s or lower. The rheometer viscosity (viscosity determined with a rheometer) of the coating composition can be determined by reading the viscosity at a shear rate of 100 sec⁻¹ from the viscosity measured at 30° C. while continuously changing the shear rate from 0.1 sec⁻¹ to 2000 sec⁻¹, using a commercial rheometer (e.g., a rheometer viscometer RHEO STRESS 1 available from Haake Technik GmbH or a comparable product) with a cone rotor (cone diameter: 35 mm, cone angle: 0.5°)

(pH)

In view of the dispersion stability and storage stability of the composition, the coating composition disclosed herein has a pH of suitably 5.5 or higher (preferably 6.5 or higher, e.g., 7.0 or higher). In view of the handling properties of the composition and suppression of coater corrosion, the coating composition has a pH of suitably 11.0 or lower, preferably 10.0 or lower, or more preferably 9.0 or lower (e.g., 8.0 or lower).

### (Solic Content (NV))

In some embodiments of the coating composition disclosed herein, the solid content (NV) thereof is suitably 25 wt % or higher (e.g., 35 wt % or higher) in view of drying efficiency, applicability, etc.; preferably 40 wt % or higher, or more preferably 44 wt % or higher in view of film-forming properties. In view of applicability and the dispersion stability of the emulsion, the solid content of the coating composition is suitably 70 wt % or lower, preferably 60 wt % or lower, possibly 55 wt % or lower, or 50 wt % or lower. The solid content of the coating composition can be adjusted by the amount of aqueous solvent used, etc. It can be adjusted, for instance, by adjusting the amount of aqueous solvent used in the emulsion polymerization or by adding water after the emulsion polymerization is completed.

### <Production of Coating Composition>

The coating composition disclosed herein can be produced, for instance, by a method that includes at least preparing a polymer emulsion that comprises an aqueous solvent, a polymer (A) and a polymer (B), and that has a viscosity of 15 Pa·s or lower at 47 wt % NV determined at 30° C. and 2 rpm using a BH viscometer; and adjusting the polymer emulsion viscosity to a BH viscosity of 25 Pa·s or higher at 30° C. and 2 rpm. In the polymer emulsion, the amount of polymer (B) included per 100 parts by weight of polymer (A) can be, for instance, 0.05 part by weight or greater, 0.1 part by weight or greater, 0.2 part by weight or greater, or 0.3 part by weight or greater. When the polymer emulsion includes less than 0.3 part by weight of polymer (B) per 100 parts by weight of polymer (A), by adding a polymer (B) to the polymer emulsion, the polymer (B) content per 100 parts by weight of polymer (A) in the final coating composition can be set to any of the aforementioned ranges (e.g., 0.3 part or greater and 5.0 parts or less by weight).

Measured at 30° C. and 2 rpm using a BH viscometer, at 47 wt % NV, the polymer emulsion has a viscosity of suitably 0.5 Pa·s or higher, preferably 1.0 Pa·s or higher in view of viscosity, or more preferably 1.2 Pa·s r higher (e.g., 1.5 Pa·s or higher). In view of polymerization stability in synthesizing the polymer (A) by emulsion polymerization, at 47 wt % NV, the polymer emulsion has a viscosity of suitably 10 Pa·s or lower, advantageously 7.0 Pa·s or lower, preferably 5.0 Pa·s or lower, or more preferably 4.5 Pa·s or lower (e.g., 4.0 Pa·s or lower), measured at 30° C. and 2 rpm using a BH viscometer.

In view of the dispersion stability and storage stability of the emulsion, the polymer emulsion suitably has a pH in the range of 5.5 or higher (preferably 6.5 or higher, e.g., 7.0 or higher) and 9.0 or lower (preferably 8.0 or lower). At such a pH, a preferable polymer emulsion has an aforementioned viscosity. For instance, a polymer emulsion having a pH of about 7.0 to 8.0 (e.g., around 7.5) is preferable.

In some embodiments, in view of helping to set the solid content of the coating composition obtained by using the polymer emulsion to an aforementioned range, the solid content of the polymer emulsion is suitably 25 wt % or higher or 35 wt % or higher, preferably 40 wt % or higher, more preferably 44 wt % or higher; and suitably 70 wt % or lower, preferably 60 wt % or lower, possibly 55 wt % or lower, or 50 wt % or lower. The solid content of the polymer emulsion can be adjusted by the amount of aqueous solvent used, etc. It can be adjusted, for instance, by adjusting the amount of aqueous solvent used in the emulsion polymerization or by adding water after the emulsion polymerization is completed.

### <Paint-Protective Coating Material>

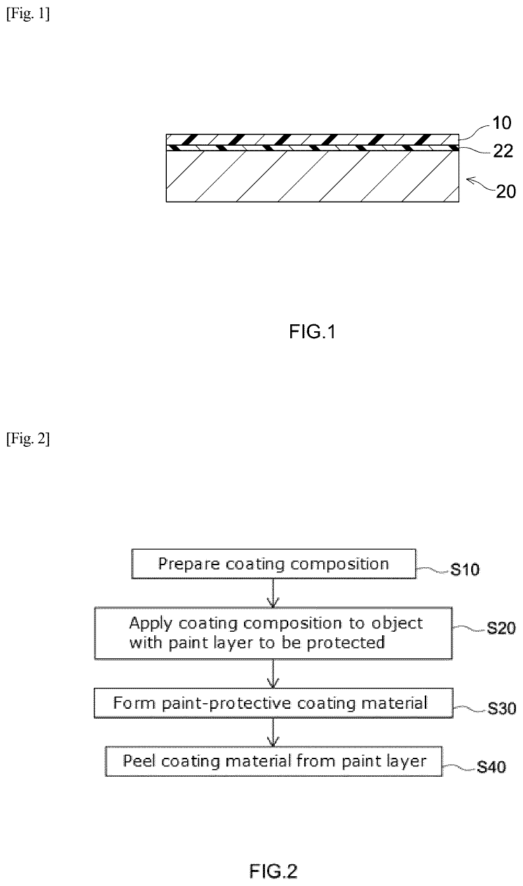

This description provides a paint-protective coating material (or abbreviated as “coating material” hereinafter) formed from the coating composition disclosed herein. The coating material disclosed herein can be formed using a coating composition as those described above. For instance, the coating composition is applied (preferably slot-die coated) onto a paint layer of an object to be protected and allowed to dry. By this, for instance, as shown in FIG. 1, a paint-protective coating material 10 formed from the coating composition can be formed on a paint layer 22 of an object 20 to be protected.

As for the method for applying the coating composition onto the paint layer of the object to be protected, it is possible to employ application with a coater such as a die coater and spray coater as well as roller coating, dip coating, etc. The die coating can be carried out by a coating system including a robot arm equipped with a slit die. For instance, by controlling the robot arm to extrude the coating composition into continuous liquid film (in ribbon form) while allowing the slit die to move along the shape of the object to be protected, even when the object has a non-flat shape (e.g., a complex three-dimensional shape such as an automobile body shell), the coating composition can be applied efficiently and precisely onto the object.

From the standpoint of increasing the efficiency and precision of coating material formation, the applied coating composition is preferably dried with heat. The drying temperature can be, for instance, about 40° C. to 100° C. and is typically preferably about 60° C. to 90° C.

The thickness of the paint-protective coating material is not particularly limited. From the standpoint of enhancing the protective effect, it is suitably 20 μm or greater. From the standpoint of the strength and removal workability, it is preferably 50 μm or greater, more preferably 70 μm or greater (e.g., 85 μm or greater), possibly 100 μm or greater, or 120 μm or greater. The coating material thickness can be adjusted through the applied amount and NV of the coating composition. In view of drying the applied composition and preventing its running, the thickness of the coating material is suitably 300 μm or less, preferably 200 μm or less, or more preferably 180 μm or less (e.g., 150 μm or less).

While no particular limitations are imposed, the coating material disclosed herein may have a storage modulus at 70° C. (G′(70)) of 0.40 MPa or higher. The coating material having a G′(70) of at least the prescribed value can be suitably removed from paint layers without excessive softening even at a temperature higher than room temperature, such as when the protected object provided with the coating material is placed outdoors in summer. From the standpoint of enhancing the removability at high temperatures, in some embodiments, G′(70) is advantageously 0.50 MPa or higher, preferably 0.60 MPa or higher, possibly 0.70 MPa or higher, 0.80 MPa or higher, or even 0.90 MPa or higher. The art disclosed herein can be implemented in an embodiment where G′(70) is 1.0 MPa or higher, 1.1 MPa or higher, or even 1.2 MPa or higher. It is also preferable that the coating material has a G′(70) of a prescribed value or lower in view of helping to prevent it from leaving marks on the paint layer. The coating material disclosed herein can have a G′(70) of, for instance, 1.30 MPa or lower, 1.20 MPa or lower, 1.10 MPa or lower, or 1.00 MPa or lower. The art disclosed herein can be implemented in an embodiment where the coating material has a G′(70) of 0.90 MPa or lower, or 0.80 MPa or lower.

While no particular limitations are imposed, the coating material disclosed herein can have a storage modulus at 23° C. (or “G′(23)” hereinafter) of, for instance, 250 MPa or higher, 300 MPa or higher, 350 MPa or higher, 450 MPa or higher, or 500 MPa or higher. The coating material having a G′(23) of at least a prescribed value tends to be less susceptible to tearing and excessive elongation while being peeled off the paint layer in a room temperature range. On the other hand, from the standpoint of reducing marking on paint layers, it is also advantageous that G′(23) is not excessively high. It is also preferable in view of removal workability because it facilitates the initial action to start removing the coating material from the paint layer (e.g., scratching an edge of the coating material with a fingernail, etc., for lifting from the paint layer). In some embodiments, the coating material can have a G′(23) of 800 MPa or lower, 750 MPa or lower, 700 MPa or lower, 600 MPa or lower, 500 MPa or lower, or 400 MPa or lower.

In some embodiments of the coating material disclosed herein, in view of non-marking properties, the coating material suitably has a storage modulus at −30° C. (G′(−30)) of, for instance, below 2200 MPa. In view of helping to better prevent marking, G′(−30) is preferably 2000 MPa or lower, more preferably 1900 MPa or lower, possibly 1800 MPa or lower, 1700 MPa or lower, or even 1600 MPa or lower. The minimum G′(−30) is not particularly limited. In view of facilitating formation of the coating material having G′(70) and G′(23) in suitable ranges, in some embodiments, G′(−30) is suitably 500 MPa or higher, preferably 800 MPa or higher, more preferably 1000 MPa or higher, possibly 1200 MPa or higher, 1300 MPa or higher, or even 1400 MPa or higher.

The storage moduli (G′(70), G′(23) and G′(−30)) of the coating material are determined by the following method: In particular, several layers of the coating material to be tested are stacked and united into one body with pressure applied to prepare a laminate film of about 1 mm in thickness. A disc of 7.9 mm diameter is punched out of the laminate film to prepare a measurement sample. The sample is placed between parallel plates. While applying a shear strain at a frequency of 1 Hz using a rheometer, the viscoelasticity is measured in the shear mode over a temperature range of −70° C. to 150° C. at a heating rate of 5° C./min to determine the storage modulus G′ at each temperature. The coating material is obtained by applying the coating composition onto the painted face (paint layer) of a painted steel plate, allowing it to dry and peeling from the painted steel plate at room temperature. As the painted steel plate, for instance, it is suitable to use a steel plate coated with an acid epoxy crosslinked acrylic paint (product name KINO1210TW available from Kansai Paint Co., Ltd.). As the rheometer, model name ARES G2 available from TA Instruments, Inc. or its equivalent can be used.

The coating material according to some embodiments has a glass transition temperature (or “RSA-Tg” hereinafter) of suitably 5° C. or higher, preferably 15° C. or higher, or more preferably 20° C. or higher. RSA-Tg is determined as the temperature corresponding to the inflection point of loss modulus G″ in viscoelastic analysis. RSA-Tg can be, for instance, 40° C. or lower, 35° C. or lower, or 30° C. or lower (e.g., 25° C. or lower). The coating material having an RSA-Tg value in these ranges is likely to have one, two or more among the aforementioned G′(70), G′(23) and G′(−30) in suitable ranges. In some embodiments, the coating material disclosed herein has a breaking strength of, for instance, suitably 12 N/25 mm or greater, advantageously 15 N/25 mm or greater, preferably 20 N/25 mm or greater, or more preferably 25 N/25 mm or greater (e.g., 30 N/25 mm or greater). For instance, a preferable coating material has a breaking strength in these ranges when it is about 100 μm to 150 μm (e.g., about 100 μm) in thickness.

In some embodiments, the coating material disclosed herein has an elongation at break of suitably 100% or higher, advantageously 150% or higher, preferably 200% or higher, possibly 220% or higher, or even 250% or higher. Such coating material can suitably deform during removal from paint layers for stress distribution; and therefore, the coating material can be inhibited from breaking due to local stress concentration. The maximum elongation at break is not particularly limited. For instance, it is suitably 500% or lower, possibly 450% or lower, or even 400% or lower. Not having too high an elongation at break can be advantageous from the standpoint of increasing work efficiency during removal. For instance, a preferable coating material has an elongation at break in these ranges when it is about 100 μm to 150 μm (e.g., about 100 μm) in thickness.

The breaking strength and elongation at break of the coating material are determined by the following method: In particular, from the coating material to be tested, a measurement sample is prepared in a 25 mm wide strip (e.g., a 25 mm wide and 100 mm long strip). In an environment at 23° C. and 50% RH, the measurement sample is set in a tensile tester. The tensile test is carried out with a gauge length of 50 mm at a tensile speed of 0.3 m/min to determine the breaking strength (N/25 mm) and elongation at break. The measurement sample can be obtained, for instance, by applying the coating composition onto the painted face (paint layer) of a painted steel plate, allowing it to dry, peeling from the painted steel plate at room temperature, and cutting into a suitable size. As the painted steel plate, for instance, it is suitable to use a steel plate coated with an acid epoxy crosslinked acrylic paint (product name KINO1210TW available from Kansai Paint Co., Ltd.). As the tensile tester, model name TENSILON available from Shimadzu Corporation or its equivalent can be used.

The coating material according to some embodiments of the art disclosed herein, in view of obtaining good removability from paint layers, the peel strength is suitably less than 4.0 N/25 mm of preferably 2.5 N/25 mm or less, determined by the following method:

### [Peel Strength Measurement]

A painted steel plate is horizontally held with the painted face up, the steel plate coated with an acid epoxy crosslinked acrylic paint (product name KINO1210TW available from Kansai Paint Co., Ltd.). Onto the painted face (paint layer) of the painted steel plate, the coating composition is applied to a non-volatile thickness of 100 μm and allowed to dry at 80° C. for three minutes to form a film (a paint-protective coating material). Subsequently, the painted steel plate was placed into an incubator at 70° C. and stored for seven days. The painted steel plate is removed from the incubator and stored in an environment at 23° C. and 50% RH for at least 30 minutes. In the film on the paint layer, two linear cuts (25 mm apart) and a cut perpendicular to the cuts are made. The film is partially removed from the latter cut and set in a tensile tester. By peeling it at a tensile speed of 0.3 m/min in the 180° direction, the film's peel strength (N/25 mm) on the painted steel plate is determined. As the tensile tester, for instance, system name TENSILON available from Shimadzu Corporation or its equivalent can be used.

In some embodiments, the peel strength is more preferably 2.0 N/25 mm or less, yet more preferably 1.5 N/25 mm or less, possibly 1.2 N/25 mm or less, or even 1.0 N/25 mm or less. Having a low peel strength is preferable also in view of reducing removal workload and advantageous in view of reducing tearing and chipping of the coating material during removal. From the standpoint of obtaining suitably tight adhesion to paint layers, the peel strength is suitably 0.1 N/25 mm or greater, preferably 0.2 N/25 mm or greater, possibly 0.3 N/25 mm or greater, 0.5 N/25 mm or greater, or even 0.7 N/25 mm or greater. It is preferable that the peel strength is not excessively low in view of preventing the coating material from unintentionally peeling off from the paint layer while protecting the paint layer.

In some embodiments, the breaking strength (N/25 mm) is suitably at least 5 times the peel strength (N/25 mm). The ratio of the breaking strength to the peel strength (i.e., the breaking strength/peeling strength ratio) is advantageously at least 8 times, and preferably at least 10 times. With increasing breaking strength/peel strength ratio, it tends to be less susceptible to tearing and chipping during removal from the paint layer being protected. From such a standpoint, the breaking strength/peel strength ratio can be 15 or higher, 20 or higher, 25 or higher, 30 or higher, 35 or higher, or even 40 or higher. The maximum breaking strength/peel strength ratio is not particularly limited. In view of helping to obtain both suitable peel strength and good non-marking properties, it is suitably 100 or lower, possibly 80 or lower, 70 or lower, or even 60 or lower.

### <Paint Protection Method>

This description provides a paint protection method comprising the following: preparing the coating composition disclosed herein, applying the coating composition onto a paint layer of an object to be protected, and drying the coating composition to form a paint-protective coating material that temporarily protects the paint layer.

An embodiment of the paint protection method is described with reference to FIG. 2. In particular, the coating composition disclosed herein is prepared (step S10). The coating composition is applied (e.g., slot-die coated) onto a paint layer of an object to be protected (step S20). The applied coating composition is allowed to dry to form a paint-protective coating material that temporarily protects the paint layer (step S30). By thus providing the coating material onto the paint layer, the paint layer can be protected from damage and degradation. The coating material after serving the protective role is removed (e.g., peeled away) from the paint layer when desired (step S40).

The matters disclosed by this description include the following:
(1) A coating composition for forming a paint-protective coating material, wherein
   the coating composition comprises a polymer (A) as a base polymer, wherein the polymer (A) is a polymer of a monomer material comprising an acrylic monomer,
   the coating composition is in the form of an aqueous emulsion in which the polymer (A) is dispersed in an aqueous solvent,
   the coating composition further comprises a polyvinyl alcohol polymer (B),
   the polyvinyl alcohol polymer (B) has a saponification degree of 80 mol % or higher,
   the polyvinyl alcohol polymer (B) has a polymerization degree of 1200 or lower,
   the polyvinyl alcohol polymer (B) is contained in an amount of 0.3 part by weight or greater and 5.0 parts by weight or less per 100 parts by weight of the polymer (A), and
   the coating composition has a viscosity of 25 Pa·s or higher, determined at 30° C. and 2 rpm using a BH viscometer.
(2) The coating composition according to (1) above, further comprising a thickener.
(3) The coating composition according to (1) or (2) above, wherein the polymer (A) is formed from the monomer material comprising a carboxy group-containing monomer.
(4) The coating composition according to any of (1) to (3) above, wherein the polymer (A) is formed from the monomer material comprising an N-containing monomer.
(5) A method for producing the coating composition according to any of (1) to (4) above, the method comprising:
   preparing a polymer emulsion that comprises an aqueous solvent, the polymer (A) and the polyvinyl alcohol polymer (B) contained in an amount of 0.3 part or more and 5.0 parts or less by weight per 100 parts by weight of the polymer (A), and that has a viscosity of 1.0 Pa·s or higher and 4.5 Pa·s or lower at solid content (NV) of 47 wt %, determined with a BH viscometer at 30° C. and 2 rpm; and
   adjusting the polymer emulsion viscosity to a viscosity of 25 Pa·s or higher, determined with a BH viscometer at 30° C. and 2 rpm.
(6) A method for protecting a paint layer, the method comprising:
   preparing the coating composition according to any of (1) to (4) above;
   applying the coating composition to a paint layer of an object to be protected having the paint layer; and
   drying the coating composition to form a paint-protective coating material that temporarily protects the paint layer.
(7) The paint layer protection method according to (6) above, wherein the coating composition is applied with a slot die.
(8) A paint-protective coating material formed from the coating composition according to any of (1) to (4) above.

### EXAMPLES

Several working examples relating to the present invention are described below, but the present invention is not intended to be limited to these examples. In the description below, “parts” and “%” are by weight unless otherwise specified. The amounts of the respective materials used are based on active ingredients unless otherwise noted.

### <Polyvinyl Alcohol Polymers Used>

PVA-1: partially-saponified anion-modified polyvinyl alcohol (Mitsubishi Chemical Corporation, product name GOHSENX L-3266)
PVA-2: partially-saponified polyvinyl alcohol (Kuraray Co., Ltd., product number 3-80)
PVA-3: partially-saponified polyvinyl alcohol (Kuraray Co., Ltd., product number 3-88)
PVA-4: partially-saponified polyvinyl alcohol (Denka Co., Ltd., product number B-05)
PVA-5: partially-saponified polyvinyl alcohol (Kuraray Co., Ltd., product number 9-88)
PVA-6: partially-saponified polyvinyl alcohol (Kuraray Co., Ltd., product number 22-88)
PVA-7: partially-saponified polyvinyl alcohol (Kuraray Co., Ltd., product number L-8)
PVA-8: fully-saponified anion-modified polyvinyl alcohol (Mitsubishi Chemical Corporation, product name GOHSENX CKS-50)
PVA-9: fully-saponified polyvinyl alcohol (Kuraray Co., Ltd., product number 3-98)
PVA-10: fully-saponified polyvinyl alcohol (Denka Co., Ltd., product number K-05)

### Example 1

### Preparation of Polymer Emulsion

In a reaction vessel equipped with a condenser, a nitrogen inlet, a thermometer and a stirrer, was placed 75 parts of ion-exchanged water. To this, was added 2.0 parts of PVA-1 as a polyvinyl alcohol polymer and dissolved at room temperature while introducing nitrogen gas. The mixture was heated to and maintained at 70° C.

In another vessel, was placed 25 parts of ion-exchanged water. Into this, were dissolved 2 parts of a polyoxyalkylene alkenyl ether (Kao Corporation, product name LATEMULE PD-420) and 0.5 part of sodium dodecylbenzene sulfonate (Kao Corporation, NEOPELEX G-65). To the resulting surfactant solution, was added 100 parts of a monomer mixture formed of 44 mol % of n-butyl acrylate (BA), 55 mol % of acrylonitrile (AN) and 1 mol % of acrylic acid (AA). The resultant was stirred and mixed to form a monomer emulsion.

To the reaction vessel, while maintaining the system at around 70° C., were added over 5 hours 0.3 part (NV) of a sodium metabisulfite solution and 0.3 part (NV) of an aqueous ammonium persulfate solution to carry out emulsion polymerization reaction. After the addition, the mixture was further maintained at the same temperature for 3 hours for curing. The resulting reaction mixture was allowed to cool to room temperature and adjusted to pH 7.5 by adding 10% ammonium water to obtain a polymer emulsion E1 (47% NV) in which the polymer (A) (polymer of the monomers) is dispersed in water. The polymer (A) has a calculated Tg of −18.8° C. based on the monomer composition and has an SP value of 11.8. The acid value of the polymer (A) was determined by the aforementioned method to be 4 mgKOH/g.

### (Preparation of Coating Composition)

To the resulting polymer emulsion E1, for every 100 parts of polymer (A) therein, was added 1.0 part of a thickener (ADEKA Corporation, product name ADEKA NOL UH-420) to obtain a coating composition C1 according to this example.

### Examples 2-12 and Comparative Examples 1-3

The species of polyvinyl alcohol polymer and its amount used were changed as shown in Table 1. Otherwise in the same manner as the preparation of polymer emulsion E1 according to Example 1, was obtained a polymer emulsion corresponding to each example.

Using the polymer emulsion corresponding to each example in place of polymer emulsion E1, but otherwise in the same manner as the preparation of coating composition C1 according to Example 1, was obtained a coating composition corresponding to each example.

### Comparative Example 4

Without using a polyvinyl alcohol polymer, but otherwise in the same manner as the preparation of polymer emulsion E1 according to Example 1, was obtained a polymer emulsion according to this example.

Using the polymer emulsion according to this example in place of polymer emulsion E1, but otherwise in the same manner as the preparation of coating composition C1 according to Example 1, was obtained a coating composition according to this example.

The polymer emulsions according to the aforementioned examples and comparative examples were all adjusted to 47% NV by suitably adding ion-exchanged water.

### <Measurements and Evaluations>

### [Viscosity Measurement by BH Viscometer]

Using a BH viscometer (available from Tokimec Co., Ltd.), at 30° C. and 2 rpm, were measured the BH viscosities of the polymer emulsion and the coating composition (i.e., viscosities before and after thickener addition) of each example. For the measurement, were used No. 2 rotor for the polymer emulsion and No. 4 rotor for the coating composition.

### [Viscosity]

Based on the results of the viscosity measurement, the increase in viscosity was determined by the following formula:

$$Viscosity increase ( Pa \cdot s ) = ( viscosity ( Pa \cdot s ) before thickener addition ) - ( viscosity ( Pa \cdot s ) after thickener addition )$$

Based on the resulting viscosity increase, the thickening properties were evaluated on the following three grades.
G (Good): viscosity increase of 30 Pa·s or greater
A (Acceptable): viscosity increase of 20 Pa·s or greater and less than 30 Pa·s
P (Poor): viscosity increase of less than 20 Pa·s

### [Polymerization Stability]

The polymer emulsion obtained in each example was filtered with a 150 mesh nylon filter (pouch) at room temperature under normal pressure and then used to prepare the coating composition for each example. Based on the filterability when the normal pressure filtration was performed on approximately 1 L of polymer emulsion, the polymerization stability was evaluated on the following three grades.
G (Good): No emulsion clumps left on the filter and no decrease in filtration speed
A (Acceptable): Emulsion clumps or deposition found on the filter, but no decrease in filtration speed
P (Poor): Many clumps of emulsion left on the filter and midway decrease in filtration speed

### [Film-Forming Properties]

Was horizontally held a painted steel plate with the painted face up, the steel plate coated with an acid epoxy crosslinked acrylic paint (product name KINO1210TW available from Kansai Paint Co., Ltd.). Onto the painted face (paint layer) of the painted steel plate, using an applicator available from TP Giken Co., Ltd., was applied the coating composition of each Example to form a 100 mm×100 mm square and allowed to dry at 80° C. for 5 minutes to form a film (a paint-protective coating material). The coating composition was applied in an amount to obtain a thickness of 120 μm by non-volatiles.

The film thus formed on the painted face was visually observed and the film-forming properties were evaluated on the following three grades:
G (Good): No cracks observed
A (Acceptable): Minor cracks without film penetration observed
P (Poor): Obvious cracks with film penetration observed

### [Drying Properties]

The film after dried at 80° C. for 5 minutes in the film-forming test was observed and the drying properties were evaluated on the following three grades. It is noted that if any aqueous solvent residue, the film will become cloudy (turbid white).
G (Good): No film cloudiness (white turbidity) observed
A (Acceptable): Slight film cloudiness observed, but cleanly peelable from the painted steel plate
P (Poor): Film cloudiness observed and not cleanly peelable from the painted steel plate

### [Non-Running Properties]

Was horizontally held a painted steel plate with the painted face up, the steel plate coated with an acid epoxy crosslinked acrylic paint (product name KINO1210TW available from Kansai Paint Co., Ltd.). In an environment at 23° C., using an applicator available from TP Giken Co., Ltd., onto the painted face of the painted steel plate, was applied the coating composition of each Example to form a 100 mm wide strip with a wet thickness of 400 μm. Immediately after application, the painted steel plate was let stand vertically. After left standing for one minute, the condition of the applied material (the composition applied on the painted steel plate) was visually observed. Based on the results, the non-running properties were evaluated on the following three grades:
G (Good): No running or sagging observed
A (Acceptable): Sagging observed, but no running
P (Poor): Running observed

TABLE 1

| | | | | Examples | | | | | | | |
|---|---|---|---|---|---|---|---|---|---|---|---|
| | | | | 1 | 2 | 3 | 4 | 5 | 6 | 7 | 8 |
| Mono- | BA | | | 44 | ← | ← | ← | ← | ← | ← | ← |
| mers | AN | | | 55 | ← | ← | ← | ← | ← | ← | ← |
| (mol %) | AA | | | 1 | ← | ← | ← | ← | ← | ← | ← |
| | Total amount | | | 100 | 100 | 100 | 100 | 100 | 100 | 100 | 100 |
| | | Degree | Degree | | | | | | | | |
| | | of | of | | | | | | | | |
| | Spe- | sapon- | polymer- | | | | | | | | |
| | cies | ification | ization | | | | | | | | |
| PVA | PVA-1 | 86.5-89.0 | 300 | 2.0 | — | — | — | — | — | — | — |
| polymer | PVA-2 | 80 | 300 | — | 2.0 | — | — | — | — | — | — |
| (part | PVA-3 | 88 | 300 | — | — | 2.0 | — | — | — | — | — |
| by | PVA-4 | 88 | 500 | — | — | — | 2.0 | — | — | — | — |
| weight) | PVA-5 | 88 | 900 | — | — | — | — | 2.0 | — | — | — |
| | PVA-6 | 88 | 1500 | — | — | — | — | — | — | — | — |
| | PVA-7 | 70 | 300 | — | — | — | — | — | — | — | — |
| | PVA-8 | ≥99 | 500 | — | — | — | — | — | 2.0 | — | — |
| | PVA-9 | 98 | 300 | — | — | — | — | — | — | 2.0 | — |
| | PVA-10 | 98 | 500 | — | — | — | — | — | — | — | 2.0 |
| NV (before thickener | | | | 47 | ← | ← | ← | ← | ← | ← | ← |
| addition) (wt %) | | | | | | | | | | | |
| Thickener UH-240 | | | | 1.0 | ← | ← | ← | ← | ← | ← | ← |
| (part by weight) | | | | | | | | | | | |
| BH viscosity | | before thickener | | 2.6 | 1.9 | 1.8 | 2.6 | 4.1 | 2.1 | 2.2 | 3.2 |
| 2 rpm | | addition | | | | | | | | | |
| (Pa · s) | | after thickener | | 48 | 44 | 42 | 48 | 60 | 50 | 51 | 52 |
| | | addition (V_{B2}) | | | | | | | | | |
| | | Increase in | | 45 | 42.1 | 40.2 | 45.4 | 55.9 | 47.9 | 48.8 | 48.8 |
| | | viscosity | | | | | | | | | |
| Evaluations | | Film-forming | | G | G | G | G | A | A | G | A |
| | | properties | | | | | | | | | |
| | | Polymerization | | G | G | G | G | A | G | G | A |
| | | stability | | | | | | | | | |
| | | Thickening | | G | G | G | G | G | G | G | G |
| | | properties | | | | | | | | | |
| | | Drying | | G | A | A | G | G | G | G | G |
| | | properties | | | | | | | | | |
| | | Non-running | | G | A | A | G | G | G | G | G |
| | | properties | | | | | | | | | |
| | | | | Examples | | | | Comparative Examples | | | |
| | | | | 9 | 10 | 11 | 12 | 1 | 2 | 3 | 4 |
| Mono- | BA | | | ← | ← | ← | ← | ← | ← | ← | ← |
| mers | AN | | | ← | ← | ← | ← | ← | ← | ← | ← |
| (mol %) | AA | | | ← | ← | ← | ← | ← | ← | ← | ← |
| | Total amount | | | 100 | 100 | 100 | 100 | 100 | 100 | 100 | 100 |
| | | Degree | Degree | | | | | | | | |
| | | of | of | | | | | | | | |
| | Spe- | sapon- | polymer- | | | | | | | | |
| | cies | ification | ization | | | | | | | | |
| PVA | PVA-1 | 86.5-89.0 | 300 | 4.0 | 0.5 | 0.3 | — | — | — | — | — |
| polymer | PVA-2 | 80 | 300 | — | — | — | 4.0 | — | — | 6.0 | — |
| (part | PVA-3 | 88 | 300 | — | — | — | — | — | — | — | — |
| by | PVA-4 | 88 | 500 | — | — | — | — | — | — | — | — |
| weight) | PVA-5 | 88 | 900 | — | — | — | — | — | — | — | — |
| | PVA-6 | 88 | 1500 | — | — | — | — | 2.0 | — | — | — |
| | PVA-7 | 70 | 300 | — | — | — | — | — | 2.0 | — | — |
| | PVA-8 | ≥99 | 500 | — | — | — | — | — | — | — | — |
| | PVA-9 | 98 | 300 | — | — | — | — | — | — | — | — |
| | PVA-10 | 98 | 500 | — | — | — | — | — | — | — | — |

| NV (before thickener | | ← | ← | ← | ← | ← | ← | ← | ← |
|---|---|---|---|---|---|---|---|---|---|
| addition) (wt %) | | | | | | | | | |
| Thickener UH-240 | | ← | ← | ← | ← | ← | ← | ← | ← |
| (part by weight) | | | | | | | | | |
| BH viscosity | before thickener | 3.7 | 1.2 | 1.1 | 3.5 | 5.1 | 2.2 | 4.8 | 0.1 |
| 2 rpm | addition | | | | | | | | |
| (Pa · s) | after thickener | 62 | 32 | 28 | 56 | 70 | 38 | 61 | 11 |
| | addition (V_{B2}) | | | | | | | | |
| | Increase in | 58.3 | 30.8 | 26.9 | 52.5 | 64.9 | 35.8 | 56.2 | 10.9 |
| | viscosity | | | | | | | | |
| Evaluations | Film-forming | G | G | G | G | G | G | G | P |
| | properties | | | | | | | | |
| | Polymerization | A | G | G | A | P | G | P | G |
| | stability | | | | | | | | |
| | Thickening | G | G | A | G | G | G | G | P |
| | properties | | | | | | | | |
| | Drying | A | G | G | A | A | P | P | G |
| | properties | | | | | | | | |
| | Non-running | G | A | A | G | G | G | G | P |
| | properties | | | | | | | | |

As shown in Table 1, the coating compositions of Examples 1 to 12 had good polymerization stability during the synthesis of the polymer (A) in the composition, with all showing good properties in thickening of the polymer emulsion, drying of the composition, forming a film, and preventing runs, making them suitable for efficiently forming high-performance protective films. In contrast, Comparative Examples 1 and 3 had low polymerization stability, and Comparative Examples 2 and 3 had poor drying properties. Comparative Example 4 using no polyvinyl alcohol polymer during polymerization was insufficient in thickening, film-forming and non-running properties.

It is noted that when a coating composition was prepared in the same manner as Example 1 but with 0.1 part of an antifoaming agent (San Nopco Ltd., NOPCO NXZ) further added per 100 parts of polymer (A) in polymer emulsion E1, the viscosity of the composition was 1.9 Pa·s before thickening and 44 Pa·s after thickening. The coating composition with a viscosity of 44 Pa·s was further evaluated for film-forming, drying and non-running properties, and was found to be good (grade G) in all. On the other hand, when a coating composition was prepared in the same manner as Comparative Example 4 but with 2.0 parts of PVA-3 further added to the polymer emulsion per 100 parts of polymer therein, the viscosity was 0.8 Pa·s before thickening and 13 Pa·s after thickening. The coating composition with a viscosity of 13 Pa·s was further evaluated for film-forming, thickening, drying and non-running properties, and was found to be good (grade G) in drying properties, but insufficient (grade P) in film-forming and non-running properties.

Although specific embodiments of the present invention have been described in detail above, these are merely for illustrations and do not limit the scope of the claims. The art according to the claims includes various modifications and changes made to the specific embodiments illustrated above.

### INDUSTRIAL APPLICABILITY

The coating composition provided by the art according to this description is suitable as a coating composition for forming a paint-protective coating material used in an embodiment where it is provided onto a paint layer of an object to be protected to serve a role to protect the paint layer from damage such as scratches and dirt and from degradation, and removed from the protected object after such a protective role is completed. Examples of possible objects to be protected include painted metal plates (steel plates, stainless steel plates, aluminum plates, etc.) having paint layers on the surface (e.g., painted steel plates used for house building materials, other building materials, transportation equipment such as watercrafts, railroad vehicles and automobiles, etc.), painted synthetic resin plates and articles molded from these. Paint-protective coating material formed from the coating composition can be preferably used for applications where it is provided onto paint layers of objects to be protected (articles having paint layers formed by paint works, e.g., metal plates such as steel plates and molded articles thereof) and protects the paint layers, with the objects having been provided with paint works using paints of various compositions such as acrylic paints, polyester-based paints, alkyd-based paints, melamine-based paints, urethane-based paints, acid-epoxy crosslinked paints, and their composites (e.g., acrylic melamine-based paints, alkyd melamine-based paints, etc.).

### REFERENCE SIGNS LIST

10 paint-protective coating material
20 object to be protected
22 paint layer

1. A coating composition for forming a paint-protective coating material, wherein
the coating composition comprises a polymer (A) as a base polymer, wherein the polymer (A) is a polymer of a monomer material comprising an acrylic monomer,
the coating composition is in the form of an aqueous emulsion in which the polymer (A) is dispersed in an aqueous solvent;
the coating composition further comprises a polyvinyl alcohol polymer (B),
the polyvinyl alcohol polymer (B) has a degree of saponification of 80 mol % or higher,
the polyvinyl alcohol polymer (B) has a degree of polymerization of 1200 or lower,
the polyvinyl alcohol polymer (B) is contained in an amount of 0.3 part by weight or greater and 5.0 parts by weight or less per 100 parts by weight of the polymer (A), and
the coating composition has a viscosity of 25 Pa·s or higher, determined at 30° C. and 2 rpm using a BH viscometer.

2. The coating composition according to claim 1, further comprising a thickener.

3. The coating composition according to claim 1, wherein the polymer (A) is formed from the monomer material comprising a carboxy group-containing monomer.

4. The coating composition according to claim 1, wherein the polymer (A) is formed from the monomer material comprising a nitrogen-atom-containing monomer.

5. A method for producing the coating composition according to claim 1, the method comprising:
preparing a polymer emulsion that comprises an aqueous solvent, the polymer (A) and the polyvinyl alcohol polymer (B) contained in an amount of 0.3 part by weight or greater and 5.0 parts by weight or less per 100 parts by weight of the polymer (A), the polymer emulsion having a viscosity of 1.0 Pa·s or higher and 4.5 Pa·s or lower at a solid content of 47 wt %, determined at 30° C. and 2 rpm using a BH viscometer; and
adjusting the polymer emulsion viscosity to a viscosity of 25 Pa·s or higher, determined at 30° C. and 2 rpm using a BH viscometer.

6. A method for protecting a paint layer, the method comprising:
preparing the coating composition according to claim 1;
applying the coating composition to a paint layer of an object to be protected; and
drying the coating composition to form a paint-protective coating material that temporarily protects the paint layer.

7. The paint layer protection method according to claim 6, wherein the coating composition is applied with a slot die.

8. A paint-protective coating material formed from the coating composition according to claim 1.
